(19) United States
(12) Patent Application Publication
(10) Pub. No.: US 2012/0330844 A1
(43) Pub. Date: Dec. 27, 2012

(54) MULTI FUNCTIONAL DUPLEX ENCRYPTED PROCUREMENT AND PAYMENT SYSTEM AND METHOD

(76) Inventor: Lance Kaufman, Scottsdale, AZ (US)

(21) Appl. No.: 13/530,888

(22) Filed: Jun. 22, 2012

Related U.S. Application Data
(60) Provisional application No. 61/500,965, filed on Jun. 24, 2011.
(60) Provisional application No. 61/500,996, filed on Jun. 24, 2011.
(60) Provisional application No. 61/513,804, filed on Aug. 1, 2011.
(60) Provisional application No. 61/528,432, filed on Aug. 29, 2011.
(60) Provisional application No. 61/533,690, filed on Sep. 12, 2011.
(60) Provisional application No. 61/539,790, filed on Sep. 27, 2011.
(60) Provisional application No. 61/545,387, filed on Oct. 10, 2011.
(60) Provisional application No. 61/549,537, filed on Oct. 20, 2011.
(60) Provisional application No. 61/566,448, filed on Dec. 2, 2011.
(60) Provisional application No. 61/622,190, filed on Apr. 10, 2012.

(51) Int. Cl. G06Q 20/40; G06Q 20/22

(52) U.S. Cl. 705/67; 705/71

(57) ABSTRACT

A device having a processor, the processor executing program instructions causing the processor to: storing credit card information of an individual in an encrypted format only readable by the processor; function as a credit card terminal by receiving an invoice for payment, wherein the invoice has a merchant key to direct payment to a specified gateway; and transferring funds from the individual to the specified gateway.

### RELATED APPLICATIONS

The present patent application is related to U.S. Provisional Application Ser. No. 61/500,965, filed Jun. 24, 2011 in the name of the same inventor listed above, and entitled, “121 Pay”; U.S. Provisional Application Ser. 61/500,996, filed Jun. 24, 2011 in the name of the same inventor listed above, and entitled, “Isquiggle—Revision 1”; U.S. Provisional Application Ser. 61/513,804, filed Aug. 1, 2011 in the name of the same inventor listed above, and entitled, “Gyro Axis”; U.S. Provisional Application Ser. 61/528,432, filed Aug. 29, 2011 in the name of the same inventor listed above, and entitled, “CURBSIDE ADS”; U.S. Provisional Application Ser. No. 61/533,690, filed Sep. 12, 2011 in the name of the same inventor listed above, and entitled, “121 Pay—Revision 1”; U.S. Provisional Application Ser. No. 61/539,790, filed Sep. 27, 2011 in the name of the same inventor listed above, and entitled, “121 Pay—Revision 2”; U.S. Provisional Application Ser. No. 61/545,387, filed Oct. 10, 2011 in the name of the same inventor listed above, and entitled, “121 Pay—Revision 3”; U.S. Provisional Application Ser. No. 61/549,537, filed Oct. 20, 2011 in the name of the same inventor listed above, and entitled, “121 Pay—Revision 4”; U.S. Provisional Application Ser. No. 61/566,448, filed Dec. 2, 2011 in the name of the same inventor listed above, and entitled, “121 Pay—Revision 5”; and U.S. Provisional Application Ser. No. 61/622,190, filed Apr. 10, 2012 in the name of the same inventor listed above, and entitled, “121 Pay—Revision 7”. The present patent application claims the benefit under 35 U.S.C. §119(e).

### BACKGROUND

Embodiments of this disclosure generally relate to a payment system, and more particularly, to a multi functional duplex encrypted procurement and payment system and method for merchants and consumers that transfer funds between accounts using a Smartphone, a PDA device, computer or a POS device and wherein the merchant instantly receives confirmation that the consumer's funds have been applied to their account.

It is generally thought that a sales transaction is a straight forward process wherein a first party purchases a product and a monetary sum is given to a second party. However, in actuality, sales transactions require numerous other steps which complicates this procedure. First, current payment systems separate sellers and buyers. Merchants typically have simplex card terminals and consumers have credit cards. However, many merchants are consumers and consumers are merchants. Rather than continuing the division creating a duplex terminal enables one user to rapidly change modes as at one moment a buyer and then as a seller. This creates faster more efficient exchange, tracking and security methods to transfer funds using a duplex virtual payment terminal rather than separate means.

Second, sales transactions are a complex process. In general, a transaction begins when the cardholder presents his or her credit card for payment. The credit card number and transaction information is entered into the merchant's transaction processing system (a credit card terminal, computer, or website). The information is then forwarded into the processor's network along with a request for authorization to secure funds in the amount of the purchase from the cardholder's credit card account. The credit card processor links up with the credit card network in order to transmit the “Authorization Request” to the Issuing Bank's computer network. The Issuing Bank verifies the credit card number and checks that the cardholder has enough money available to fund the transaction. A “hold” for the transaction amount is placed on the cardholder's account, thus reducing the available balance for future transactions. Once the approval is received the processing network sends a response to the merchant's credit card terminal or computer interface. At the end of the business day, the merchant sends a request to the processing network to secure the authorized funds from all the credit card transactions conducted throughout the day. The total amount of all the credit card transactions, minus any processing fees, is then deposited into the merchant's business bank account. Thus, simplifying this process and speeding up the transfer of funds is desirable.

Therefore, it would be desirable to provide a system and method that overcomes the above problems.

### SUMMARY

A device having a processor, the processor executing program instructions causing the processor to: storing credit card information of an individual in an encrypted format only readable by the processor; function as a credit card terminal by receiving an invoice for payment, wherein the invoice has a merchant key to direct payment to a specified gateway; and transferring funds from the individual to the specified gateway.

A device having a processor, the processor executing program instructions causing the processor to: create an invoice by a merchant; transfer selected items entered into an account catalog to a device of a consumer; sending an invoice to the device of the consumer wirelessly; adding a desired tip by the consumer on the device of the customer; select payment method on the device of the customer; signing the invoice on the device of the customer; and transfer the invoice back to the merchant.

A method for credit card payment comprising: storing credit card information of a first individual in an encrypted format on a device of the first individual; sending e-card information related to the credit card to a server prior to giving a second individual the credit card, wherein sending the e-card information opens a payment gateway window; and authenticating credit card information to allow entry of the consumers shortly to arrive swiped credit card entered or swiped by the merchant.

A credit card payment method comprising: sending an encrypted virtual card to an electronic device of a consumer and a corresponding physical card to a physical location for receipt by the consumer by a credit card issuing company; and comparing the virtual card and the corresponding physical card, wherein the virtual card and the corresponding physical card must match to complete a transaction.

A payment method comprising: capturing a QRCode from a printed invoice of a merchant; approving the invoice by a customer; transfers funds to an account of the merchant via an IP address and or a unique key translated from the QR code and or location information acquiring that related information from a server; and sending confirmation of payment and receipt to the customer and merchant.

A method for tracking payment comprising: purchasing electronic tokens, wherein each token has a plurality of identifiers related to a specific device and user; transferring at least one electronic token during a transaction; recording transfer of the at least one electronic token and the plurality of identifiers associated with the at least one token on a server; and debiting and crediting a number of electronic tokens for each party of the transaction.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified functional block diagram showing operating of the present invention;

FIG. 2 shows a screen shot of an electronic device having the Fast Lane app;

FIG. 3A shows a simplified breakdown of the differences between the Merchant and Consumer account functions of the Fast Lane app;

FIG. 3B-3C shows the traditional credit card flow and the bypass credit card flow respectively;

FIG. 4 shows screens dashboard for the merchant and consumer;

FIG. 5 shows screens shots for a consumer Safe setup for the Fast Lane app;

FIG. 6 shows how a card reader may be used with a Smartphone having the Fast Lane app;

FIG. 7 shows the Bluetooth or Proximity transfer feature of the Fast Lane app;

FIG. 8 shows the point transfer feature of the Fast Lane app;

FIG. 9 shows the tap feature of the Fast Lane app;

FIG. 10 shows the iSquiggle feature of the Fast Lane app;

FIG. 11a-11D shows operation of the iSquiggle feature of the Fast Lane app;

FIG. 12A-12E shows the acceptance or rejection authority and comparison techniques of the iSquiggle feature;

FIG. 13 shows another Tap verification technique requiring one tap on both screens

FIG. 14 shows another version of the iSquiggle and subsequent selection feature;

FIG. 15A is a screen shot showing the QR2 feature of the present invention;

FIG. 15B shows different screen shots for merchant to consumer sequence;

FIG. 16 is a screen shot showing the Card2Match feature of the present invention;

FIG. 17 shows operation of the app if a merchant has POS without the Card2Match plus feature;

FIG. 18 illustrates payment radius restrictions usage of the present invention;

FIG. 19 illustrates Fast Lane Order feature of the present invention;

FIG. 20 illustrates Fast Lane Coupon feature of the present invention;

FIG. 21 illustrates a Payment Area Restrictions and Automated Exchange feature of the present invention;

FIG. 22A illustrates a micro zone feature of the present invention;

FIG. 22B shows location verification;

FIG. 22C shows a Moving Merchant feature of the present invention;

FIG. 23A illustrates a Fast Lane Checkout feature of the present invention;

FIG. 23B shows screen flowchart shots of a device having a Fast Lane Checkout feature of the present invention;

FIG. 23C shows a flowchart of operation;

FIG. 24A-24B shows data read from a QR scan;

FIG. 25A-25B shows screen shots from a Consumer's Smartphone displaying the product photo and receipt using the app of the present invention;

FIG. 26 shows the consumer's Smartphone scanning a paper receipt having a QR code using the app of the present invention;

FIG. 27 shows the consumer's Smartphone scanning a paper receipt having no QR code using the app of the present invention;

FIG. 28 shows further details of the Fast Lane Checkout feature of the present invention;

FIG. 29 shows another use of the present invention for online purchases;

FIG. 30 shows a QR code template for use in the present invention; and

FIG. 31 shows another QR code template for use in the present invention.

### DETAILED DESCRIPTION

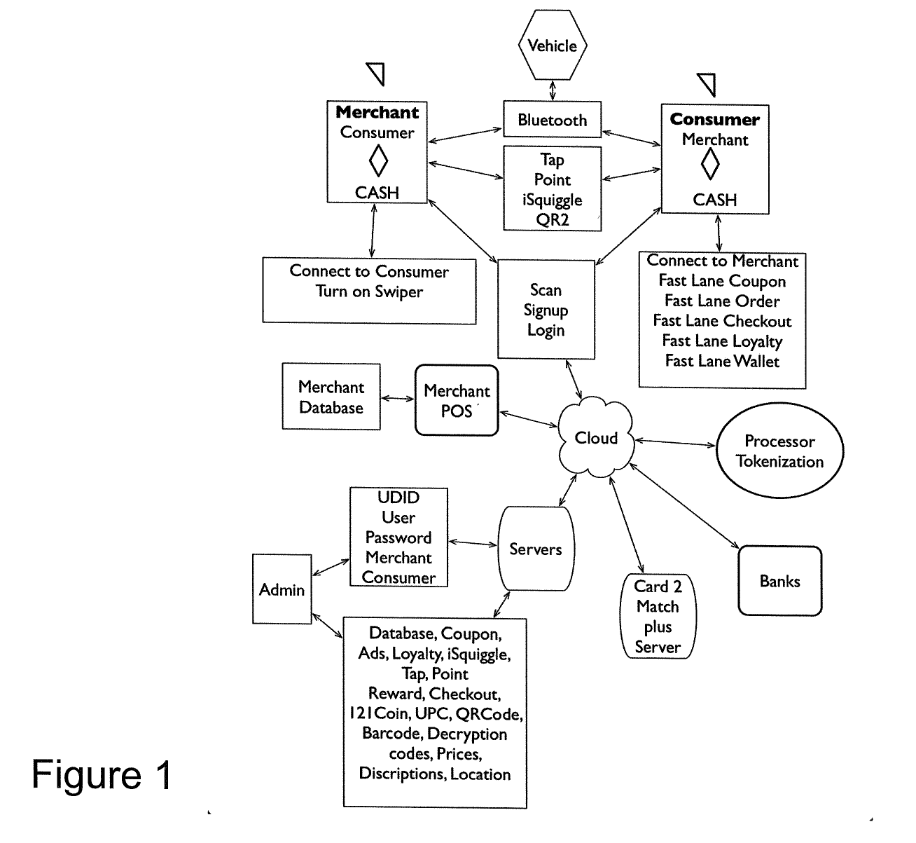

Referring to the Figures, the present invention, hereinafter called Fast Lane, will be described. As shown in FIG. 1, Fast Lane is a multi functional duplex encrypted procurement and payment application (app) for merchants and consumers that transfers funds between accounts using a Smartphone, a PDA device, computer or a POS device. Fast Lane Checkout is one of the options that when launched by a consumer, scans the QRCode or Barcode or other code labels of the product or service they wish to procure in a physical or virtual environment and press Process to pay. The merchant instantly receives confirmation that the consumer's funds have been applied to their account.

Fast Lane Coupon is another complementary feature. It automatically displays special coupon offerings when driving or walking near a participating merchant. Once the consumer accepts an offer, the order is placed in motion enabling the buyer to bypass ordering and payment lines.

Connect the third choice creates a secure encrypted exchange channel when a seller and buyer establish a secure channel press: (Connect to Consumer) and (Connect to Merchant) using Tap or Point or iSquiggle or QR2 or Bluetooth or accelerometers. This exclusive link allows identity, invoice, billing, transaction and receipt History to be exchanged between a seller and a buyer using an iPhone, iPad or iPod touch, Smartphones in proximity to each other and to near or distant virtual POS terminals. Connect has two operational modes. One is as the consumer and the other is as the merchant. That means any consumer having a business has a ready-to-go credit card terminal and any merchant can open a consumer account using the same app. Each user's device is entitled to one consumer and one merchant account with each requiring separate username and password—a Duplex function. Transactions can use credit, debit, stored value and 121Coin.

The control panel CASHKey represents (Charge, Account, Safe, History and Key) the master dashboard directory. Card swipe terminals can be used in both the consumer and merchant modes for card or indirect token entry into the consumer's Safe for direct or indirect card recall for current and subsequent payments. Tokens and cards can be complete or partial representations with feedback provisions alerting users to fraudulent transactions. Card 2 Match gives both consumer and merchant extra card fraud prevention options.

In order for a merchant to operate the Fast Lane app, the Merchant may need to download the Fast Lane application (the word app and application have two different meanings in this latter case it's a document that needs to be filled out) and create a secured account. The secure account may be done online or the merchant may fill out a merchant application manually and return it. The application is then processed. An encrypted Key may then be assigned and a management account can be setup. The Smartphone or a PDA device which downloaded the Fast Lane app is now ready to use Fast Lane. Merchants can use the app as a card terminal for processing, a POS terminal, an invoice generator with a tip calculator for the consumer, a catalog for items with price and tax information, and a means to interface with the consumer so as to create coupon and loyalty programs as will be described below.

For a consumer to use the Fast Lane app, the consumer may need to download the Fast Lane app to a Smartphone or a PDA device. The consumer may then need to create a secured account. The consumer may need to enter credit cards, debit cards and stored value cards, 121Coin tokens into a Safe and create a unique photo identity. The Smartphone or a PDA device is ready to use the Fast Lane. Consumers can store credit, debit and stored value cards in the Safe as a back up to a traditional physical wallet. If a consumer forgets his/her old wallet, with this app you can recall your cards from the Safe and continue to use those cards by electronically transferring that information to a merchant.

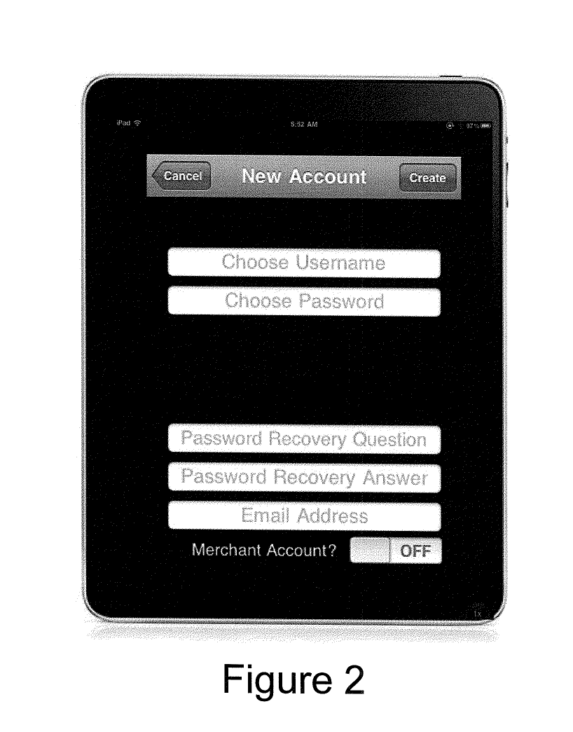

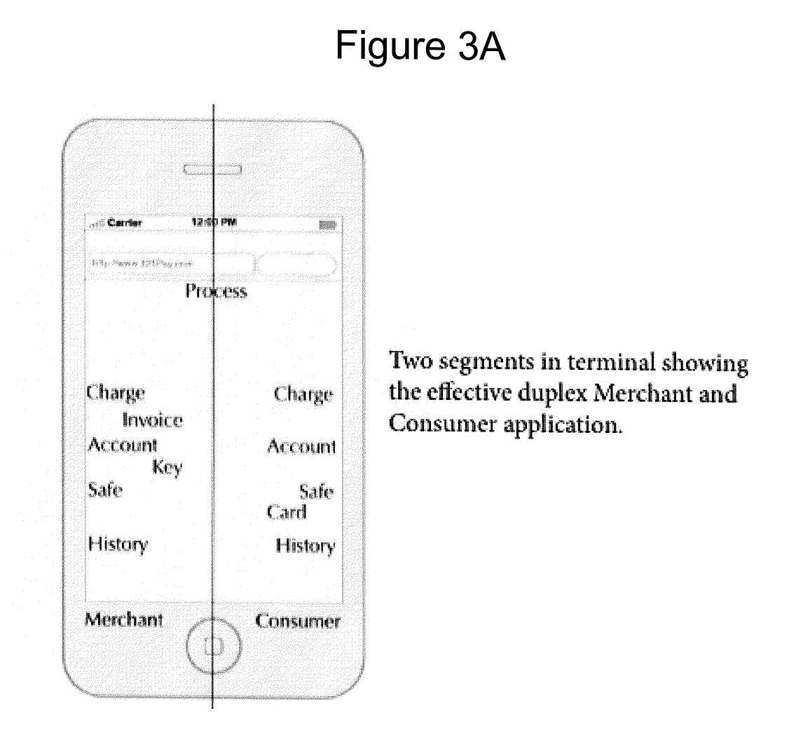

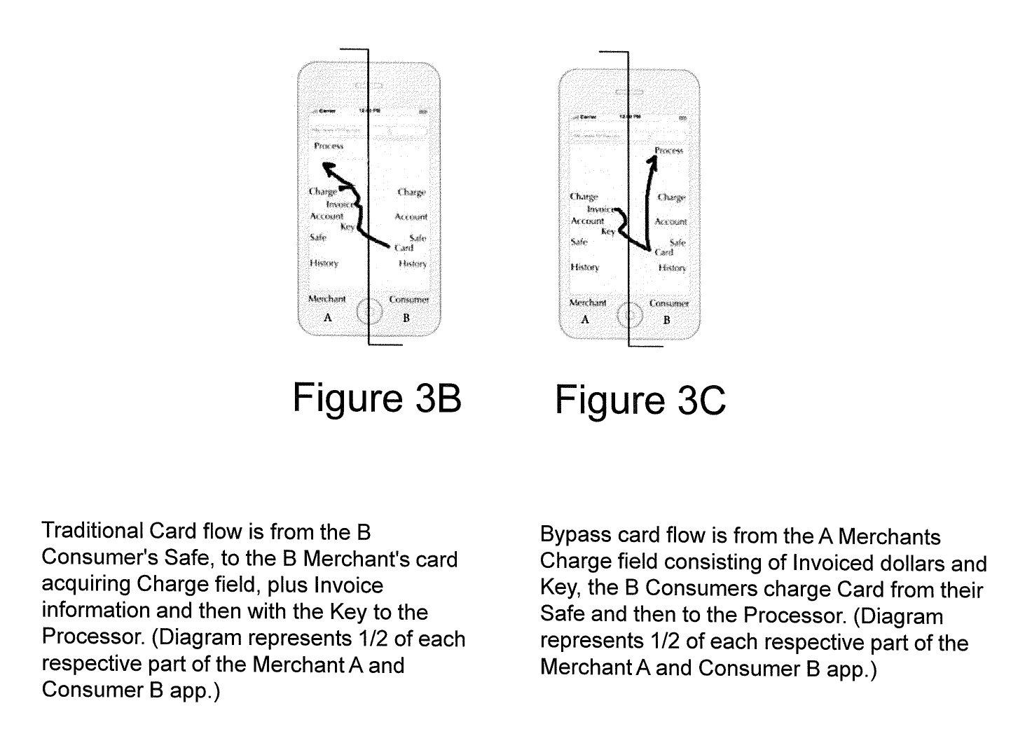

As shown in FIG. 2, a screen shot of an electronic device with the Fast Lane app downloaded is shown. The Fast Lane app may provide an option to create two accounts a Consumer and a Merchant in one application. If both a Consumer and a Merchant account are created, separate login identifications may be used. FIG. 3A shows a simplified breakdown of the differences between the Merchant and Consumer accounts.

Credit card terminals are historically designed to accept cards from consumers by merchants. However, there are security exposures to each transaction and consumer's information is exposed every time a consumer gives their credit card to the merchant for processing. To eliminate this exposure segments of the basic procedure as discussed above in Fast Lane are altered to create a card bypass feature.

To do this some of the links and procedures relating to the merchant card terminal and the credit card Safe within the consumer's application are altered. These changes eliminate the need to give merchant direct card information. The Safe within the consumer's side of the application continues to stores credit cards or as a token in an encrypted format that is only readable by the processor. The card terminal compartment now within the consumer's application is designed as a onetime per transaction terminal. The merchant creates the invoice and sends it to the consumer as previously described but additionally includes a special encrypted merchant's Key. The Key directs the payment packet to a specific gateway, processor and ultimately to the merchant's specific account into which the funds are to be deposited. A unique time dependent and random Key can be generated for each of the merchant's transactions which is issued by the processor or a standard encrypted Key can be used. It's given to the merchant for processing per each transaction that is to take place and is to be transferred to the consumer along with the merchants invoice. The consumer, in these arrangements is the party pressing Process button and thus connects with the processor per the unique encrypted Key to sends their card information along with the merchants encrypted one time deposit account information and the funds due as determined by the merchant's electronic invoice. Upon completion both parties are notified of the transaction acceptance or rejection. Consumers and merchants are given a mutual option in the application to use a traditional card with a Swiper (card reader) or the card bypass feature. Since the security benefits resides essentially with the consumers in the form of protecting their data fees may be accessed to the consumers reducing the financial burdens placed exclusively on the merchants may be shared if mutually agreed by both parties. Smartphones and PDA devices may require Bluetooth, WiFi, Cellular and or other communications to use the card bypass feature.

FIG. 3B shows the Traditional Card flow is from the B Consumer's Safe, to the B Merchant's card acquiring Charge field, plus Invoice information and then with the Key to the Processor. (Diagram represents ½ of each respective part of the Merchant A and Consumer B app.)

FIG. 3C shows the Bypass card flow is from the A Merchants Charge field consisting of Invoiced dollars and Key, the B Consumers charge Card from their Safe and then to the Processor. (Diagram represents ½ of each respective part of the Merchant A and Consumer B app.)

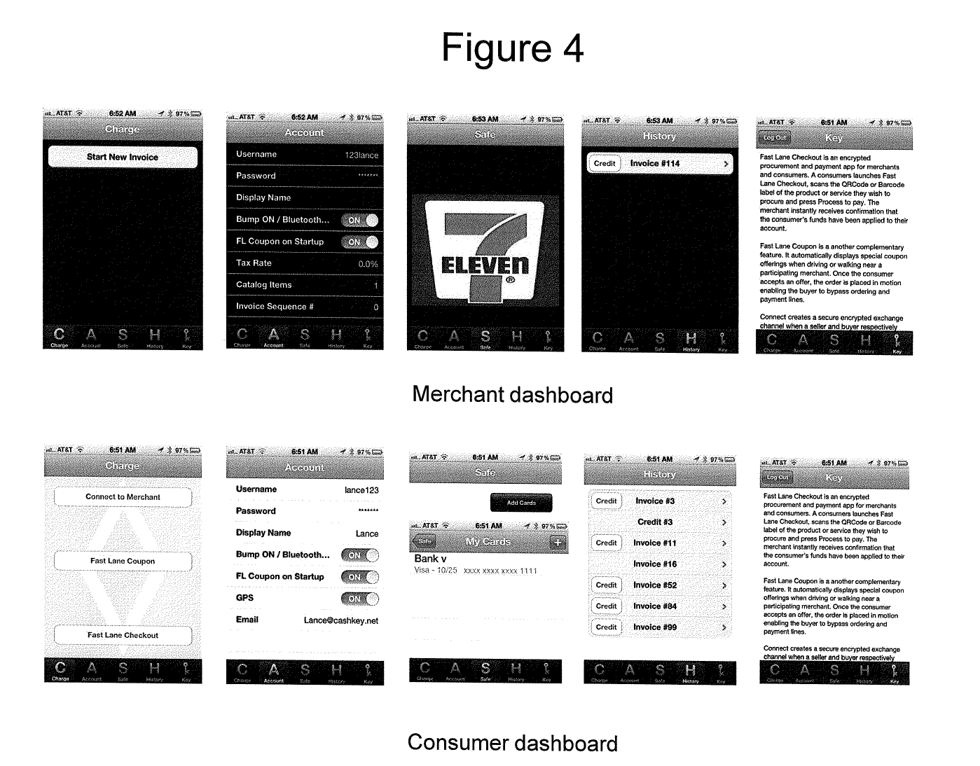

As shown in FIG. 4, different screen shots are shown. The screen shots show the difference between a merchant dashboard and a customer dashboard for a device 10 having the present invention.

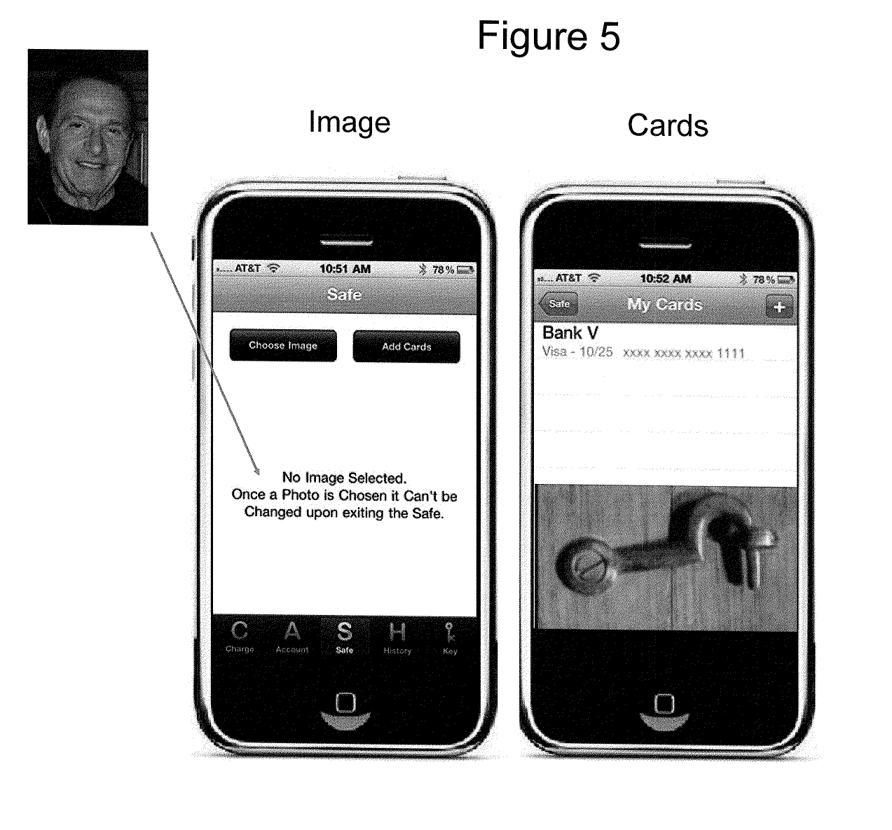

Referring now to FIG. 5, a consumer Safe setup will be disclosed. When setting up a consumer's Safe, the user may be required to select an image/picture. The image/picture is associated with the credit cards in the Safe. Once an image ID is selected it can only be changed by deleting the application. If the application is delegated, all credit cards are purposely deleted. This sets up a reload sequence that thwarts fraud.

Once an image/picture is selected, the consumer's debit and credit card information may be entered. This information may be encrypted. Once the information is entered and encrypted, the information may not be edited. As may be seen in the figure, only the last 4 digits of any credit/debit card may be available for viewing. Card issuer offers a Credit or Debit Card with Card 2 Match plus security in the application. Consumer accepts and receives an encrypted Virtual card on their Smartphone and its reciprocal Plastic card is sent in the mail.

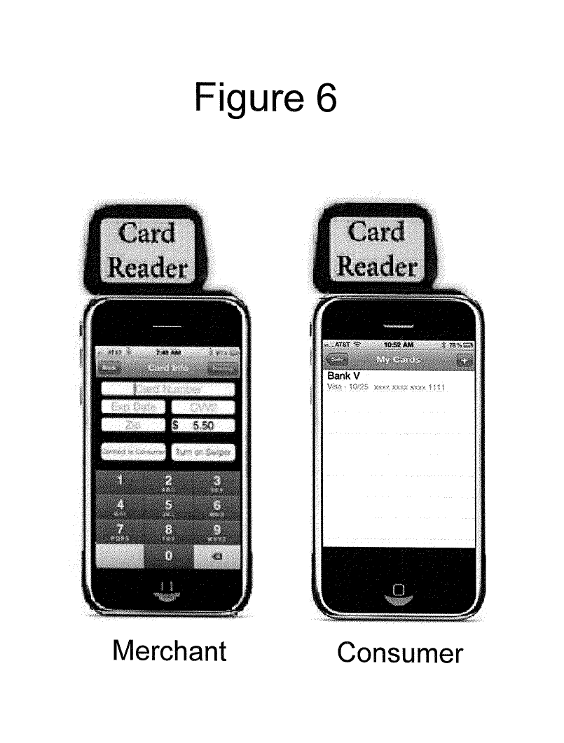

As shown in FIG. 6, a card reader can be used by the merchant to swipe cards associated with transactions or tokenization or it can be used in the consumer mode to swipe a card, enter the card information into the consumer's Safe or pass the data pack to a processor or secure vault between the device and processor to acquire an assigned or unassigned encrypted token that represents that card that is placed into the consumer's Safe. Typically cards are identified as cards not present or cards swiped. Swiped cards receive a lower transaction merchant fee. Loading the results of a swiped card with an injected key into the Safe as with a tokenization result means merchants will encourage this methodology. Consumers will further reduce card exposure.

Another feature of Fast Lane is a feature called 121Coin. 121Coin allows merchants and consumers to exchange electronic 121Coins in place of or in conjunction with other payment methods so as to create a totality of traceability. This is in addition to performing traditional credit and debit card exchanges. 121Coins are acquired from a website, for example, www.121Coin.com. The coins are unique, identified and serialized electronic coin tokens for exchange between other Fast Lane accounts. For example, consumer (A) procures 10 121Coins. They receive 10 121Coins and each is identified as 10121Coin(A). (The identification has a random component and numerous identifiers that relate to a specific device and user beyond the simplified example.) When (A) transfers 5 coins to (B) its recorded at both location's 121CoinCloud accounts as −5121Coin(AB) to (A)'s account and +5121Coin(BA) to B's account as well reflected on each device. In effect each transaction has a new identifier with a tracer component generated. Ultimately, the system knows how many 121Coins are issued, to whom and with who a trade was transacted. 121Coins also have a programmed self traceability. If those 10 121Coins are traded between 50 users or an infinite number of users a chain identifier is tagged as historical to each token. When all of the issued 121Coins are redeemed those numbers are terminated and never used again. 121Coins can be used to represent cash that is redeemable into traditional funds or act as a standalone entity representing another means of value assignment for coupons, loyalty, rewards, gifts, games. To use this exchange the consumer/merchant account does not have to have traditional merchant approval requirement as every 121Coin and transaction is traceable.

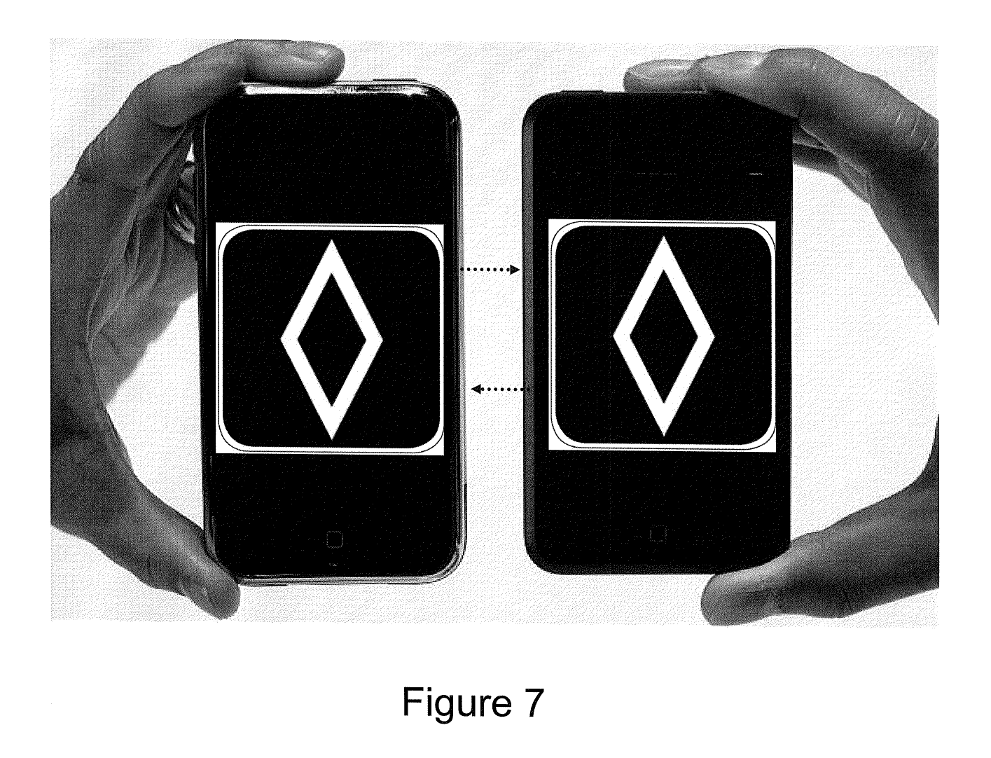

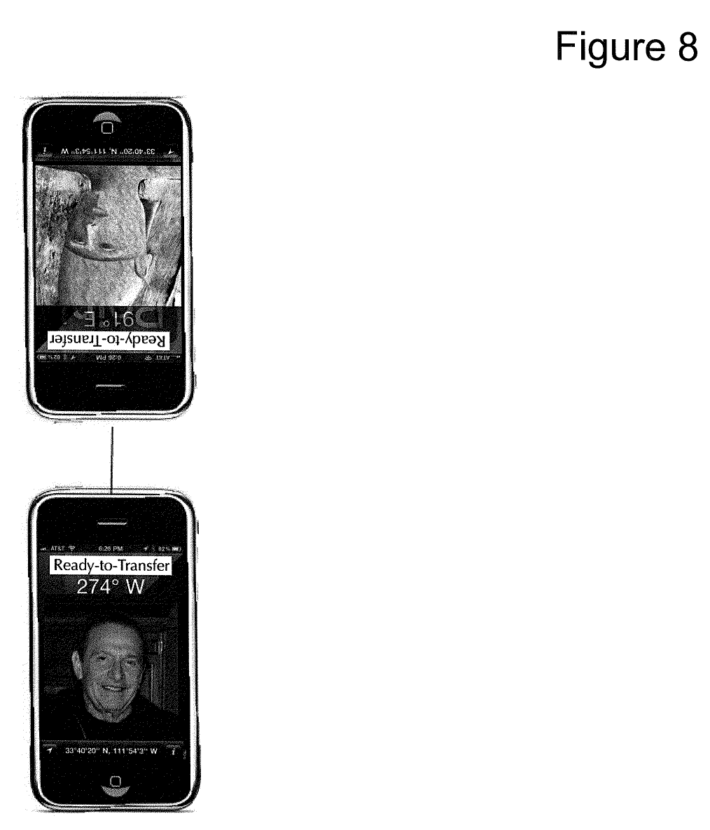

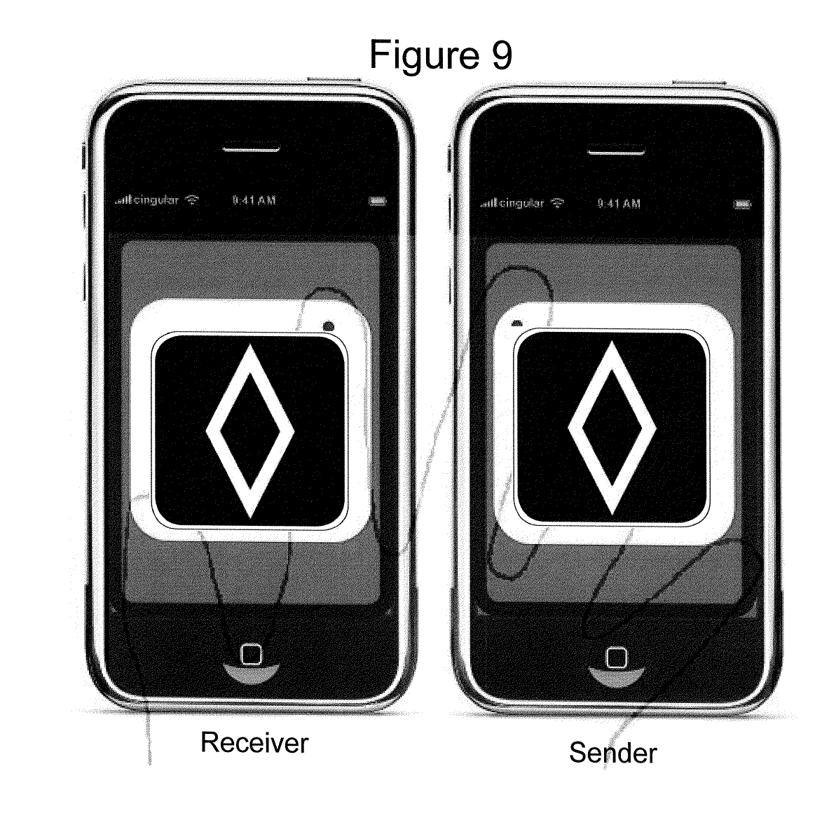

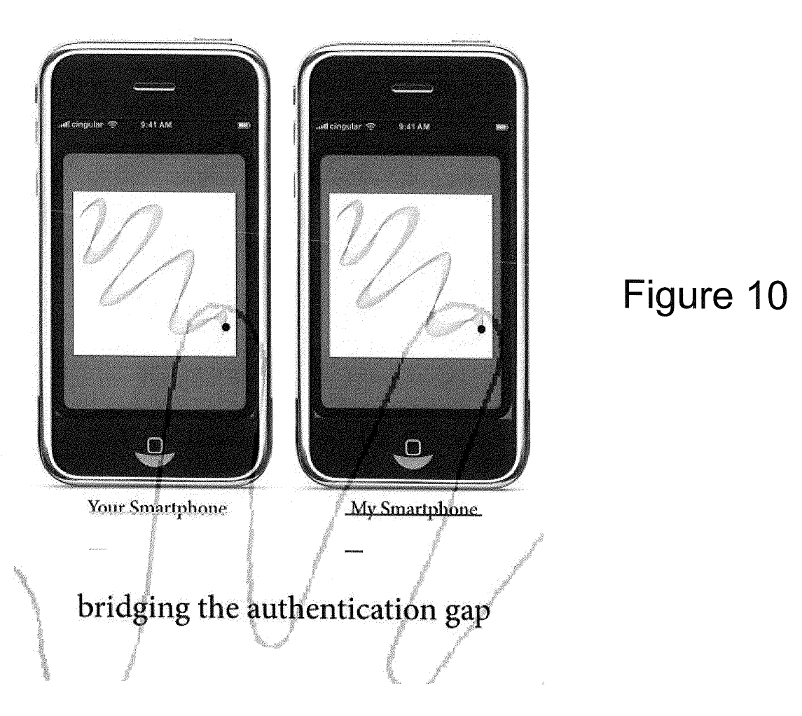

Referring now to FIG. 7-11, Fast Lane further has a component called Connect. The Connect feature using Tap (FIG. 9) or Point (FIG. 7-8) or iSquiggle (FIGS. 10-12C) or Bluetooth or accelerometers with an iPhone and iPod and or other devices establish a secure channel through means described and the subsequent secure exchange of data with one device and or both having an Internet or cellular connection.

As shown in FIG. 7, the two devices may be aligned in the same direction side by side or FIG. 8 just pointed towards one another. After launching the application on the two devices, the sender of data, for example, taps (FIG. 9) once on each device's touch screen at the same instant. Tap is now launched on the two devices. Based on location, time and tap sequence users are authenticated. One or both users tap a selected exchange. The sequence of the tap determines the order of transferred data. Data is sent from both devices to a server that evaluates location information, compass headings (359+−15), tap times (+−0.2 second) and their sequence so as to authenticate the subsequent transfer of selected data between the devices or open another program.

Referring to FIG. 10-12E, iSquiggle is a line and/or mark authentication application. The consumer creates a mark on two devices their's and the merchant's at the same time with one hand and fingers bridging both devices the mark is created. It resides on devices and sends information as data or captured images, along with the time and location to a server. A central server may be used to determine the similarity or dissimilarity of the data from devices at the same time and create an acceptance or rejection authority. In financial transactions there are anti-fraud benefits.

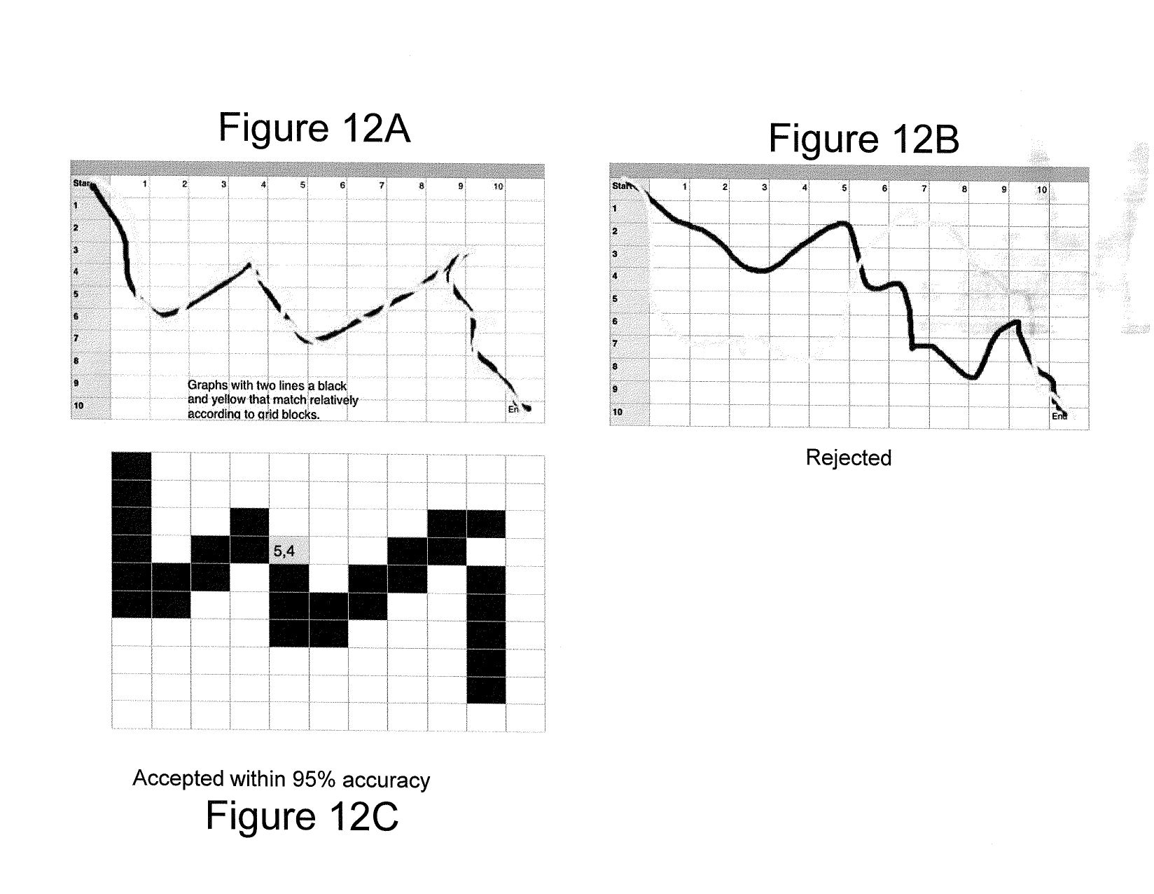

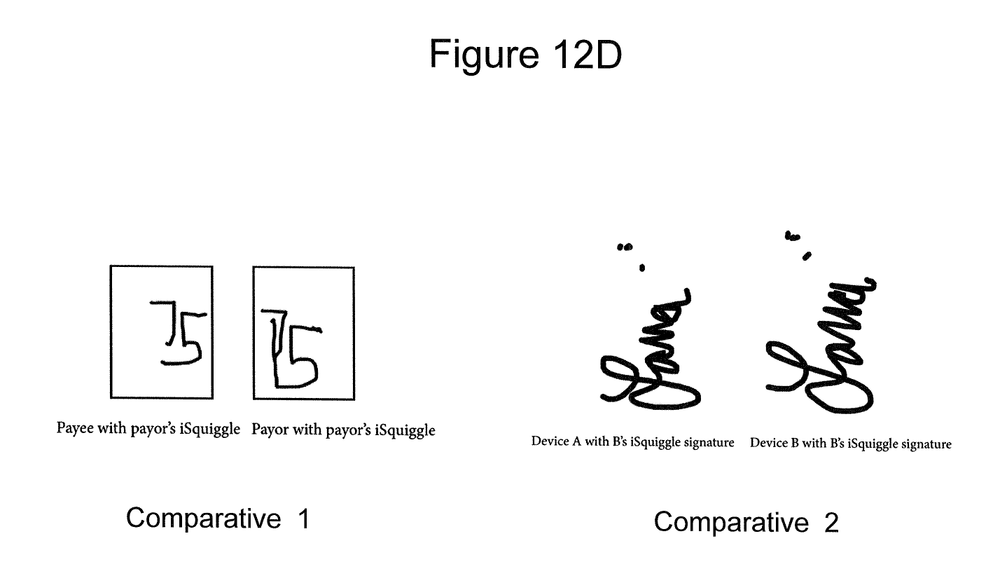

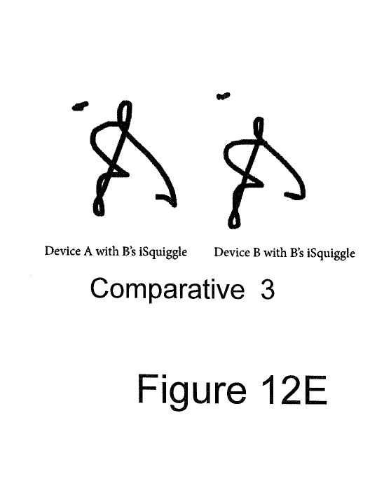

iSquiggle typically resides on at least two devices as Smartphones that have screens capable of capturing a iSquiggle (lines and or marks that can be visible or transparent) and sending that information as data or captured images, along with the time and location from both devices to a central server that will subsequently ascertain the similarity or dissimilarity of the data from two devices at the same time and create an acceptance or rejection authority (See FIG. 12A-12C). Current credit card signatures are maintained by the merchant for dispute resolution only.

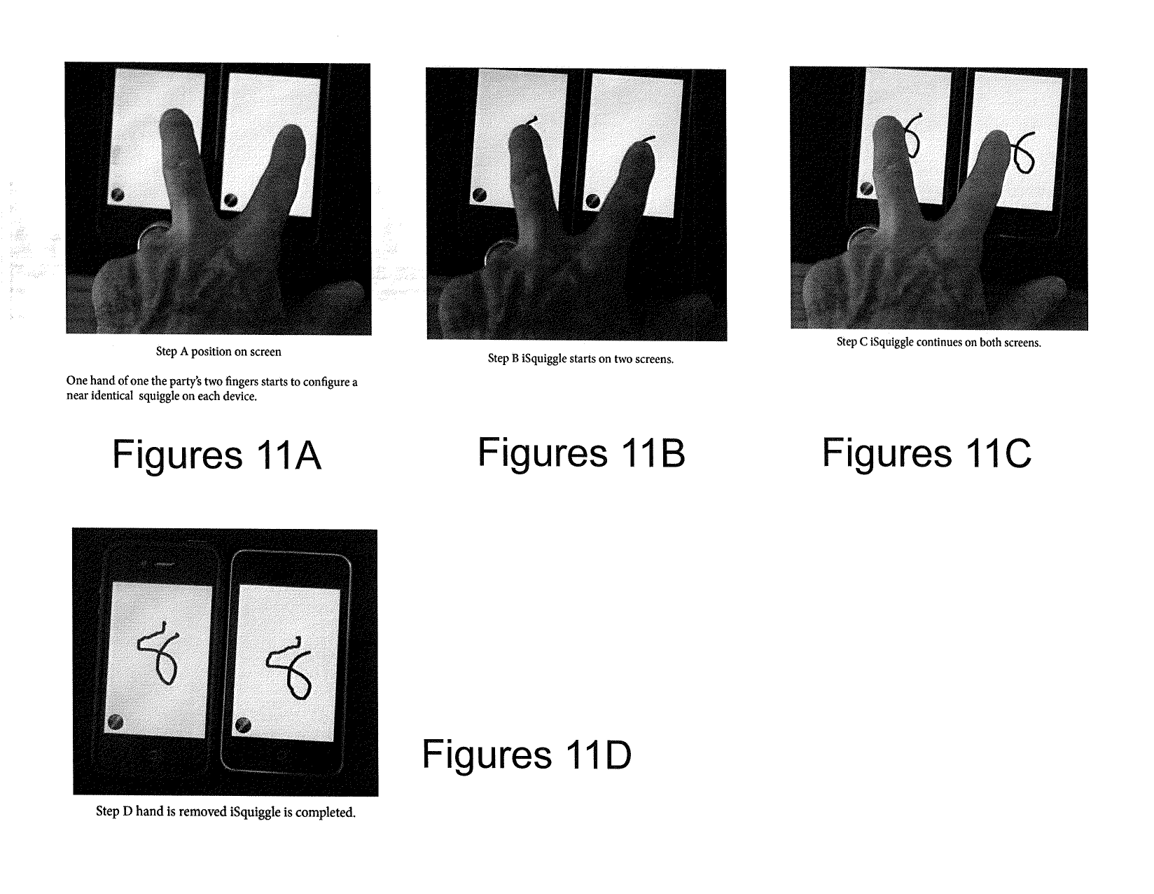

iSquiggle (line or marks or combination of both) can be generated in proximity to two devices by one individual as doing a squiggle with two fingers of preferably the same hand on one device and another finger of the same hand on an adjacent device to create a near identical and unique iSquiggle at the same time (See FIGS. 11A-11D). Squiggles once compared are not necessarily stored on the central server as that is the choice of the users. An iSquiggle can be a unique signature that is used over again and/or the user or users can create a onetime iSquiggle on two unique identified devices (UDID) with a relationship using time, location and a signature or iSquiggle. Location information has limits while a near identical and unique squiggles at the same time increases the validity between two individuals in a one-to-one exchange as between a payer and a payee in a financial exchange or an exchange of personal information.

Once verification occurs other aspects of the application are launched. In effect iSquiggle is a security door that switches opens when two devices iSquiggles match and occur at the same time and other attributes as signing up for the application which captures pertinent information unique to the device and the individual that are used as determining factors by the server's electronic authority. As previously stated, Current credit card signatures are maintained by the merchant for dispute resolution only.

iSquiggles can be expanded to create higher levels of security and open specific functions. Higher levels can include a break or breaks (taking samples) within a few milliseconds before transmission to the server with another iSquiggle. iSquiggles can be visual and disappear as the marks progress. Specific login iSquiggles can also achieve several functions as authentication and opening other specific programs on a singular device or both devices. So a specific exchange can take place as a iSquiggle resembling a $ for Pay, M for Music, D for Document, P for Photo etc. As to which party enters the iSquiggle first is determined by the individuals. In some cases it may be one individual and in another case it could be one then the other. The default is typically the party transferring the information. Some instances may require one party to iSquiggle and then the other party to enter other iSquiggles. Random requests from the server can also be used as coded prompts that can be set up with user's progressive and or altered commands as Monday its X and Tuesday its Y.

iSquiggle is a dual stamp of time and place that captures a signature and or other iSquiggles that can also link to a traditional credit card and Near Field Communication (NFC) card to enhance security and can be a requirement to complete a transaction before and or after the swipe or NFC read takes place. In the case of a credit card the third magnetic stripe or an embedded data field in an NFC chip sends a signal to the user from the iSquiggle server that looks at this additional information for verification prior to and or an amount for processing by the merchant to the consumer. The consumer has an option to approve or disapprove the transaction on their device separate from the card. This ties the card to a set of devices and iSquiggles. Should the consumer wish to terminate the transaction because of a suspected fraud they have that option as they are alerted to an event in which they are not participating. That feature can be carried to a further extent if the consumer determines that their credit cards are lost by instantly notifying the card issuer that they wish to terminate the card totally. Further if a device is not present with a charge then a “notify me” popup is sent to the consumer (the merchant's location is used and that of the consumers device).

iSquiggle has a dual signature mode that acquires two signatures and or iSquiggle marks, (written and or voice or both) that can contain breaks and discontinuous lines that are generated by the same individual onto two devices with the acquired information sent to a server at the same time from two devices and the signature and or marks are compared for probable identical attributes, assessed and or referenced against a standard for the individual as a signature or unique mark on the servers database that results in approval or denial. Other factors can also be referenced as GPS location, triangulation, server registered location if used in the transaction and time. The issue of proximity is effectively reduced to the distance between two fingers on one hand. That assurance uniquely pegs two devices to a specific relationship. Further the system can be set up so each party's signatures or marks are required to authenticate a transaction. That feature does not exist with any of the prior art methods described above.

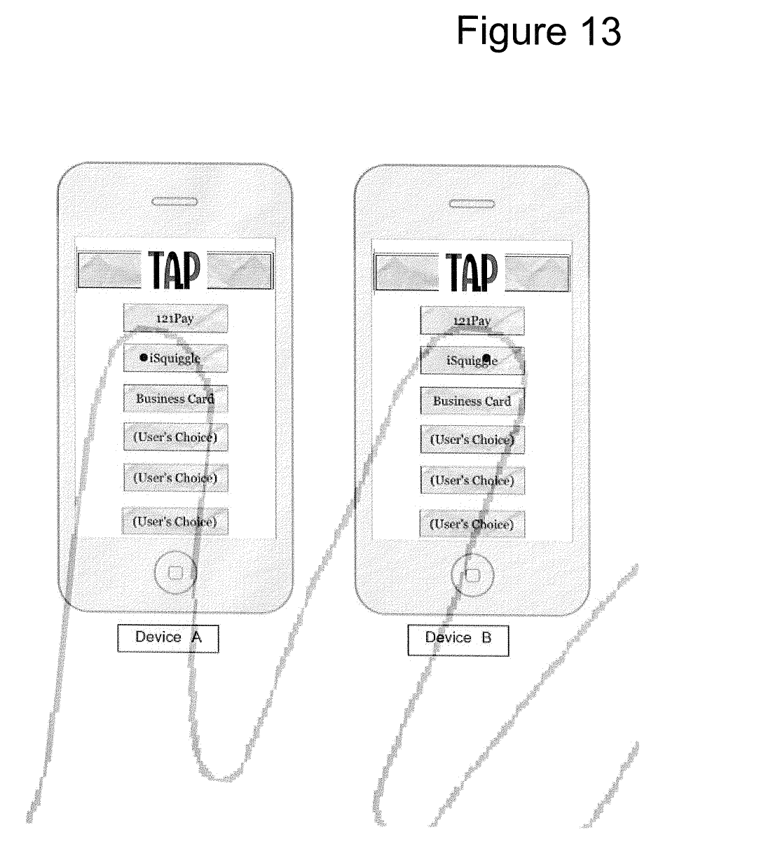

Referring to FIG. 13, another iSquiggle verification technique requires one tap on both screens followed by the iSquiggle motion which can be a random design and or a signature and three subsequent taps on both screens indicating both devices are to send their respective data to a server. In addition to any of these marks a reference can be maintained on the server as a reference for further verification. The iSquiggle design can also be viewed and used as a temporary one time unique key on the payee's device from the payer.

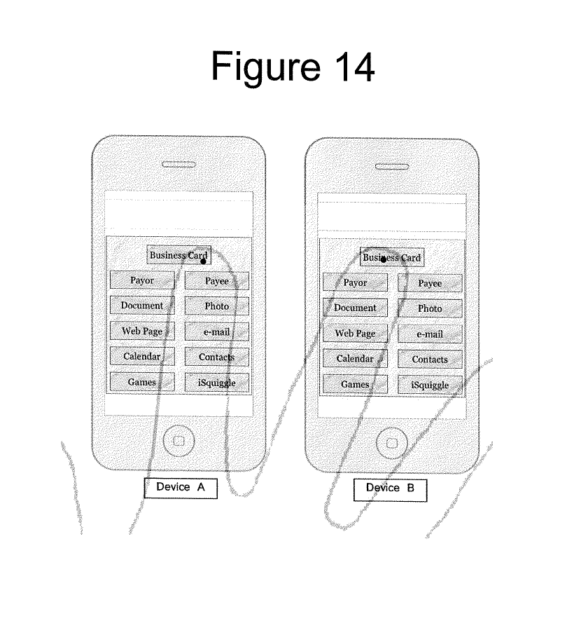

Referring to FIG. 14, iSquiggle can also exist in a simplified form that is essentially as a grid with blocks and symbols or icons. Once the application is launched on each device the same screen appears on both devices. A selection of a given set of choices is presented as Payments, Payee, Payer, Photos, Documents, Business Card etc. This is referenced as iSquiggle icon. The activation can be as described with one individuals hand and two fingers with one finger on each of two devices so the selected screens and the same icon are tapped at the same time. Alternatively, each user can touch the designated icon at the same time. All of the other factors remain as proximity being a critical factor. It's also reasonable to combine the iSquiggle pad, the main embodiment of the application, with icons selection points to accelerate going to a given application. Additionally, a set of blank grids can be used in place of the iSquiggle pad to reduce the complexity of the iSquiggle comparative. This is referenced as iSquiggle grid. In the case of a set of grids several hundred may exist on a screen. When touched those definitive grid blocks are turned on. Essentially the definition is reduced and pixel size is increased.

In iSquiggle, voice may also be implemented with the writing applications or operate as a standalone function. Voice packet patterns as generated on each of two phones from one or both parties may be sent to the servers for analysis. The pattern can be used from the phone or sent to the server for generation. With this application a high sub audible frequency with random short bursts is sent from one device to another to assure near distance exchanges. Random questions can be asked and other requests can be made as to generate a iSquiggle related to a security stored symbol. The voice patterns can have specific instructions as “pay twenty five dollars” from the payer and those patterns are compared against a learned and stored pattern maintained at the server.

Alternatively, each user can create a copy-cat motion on their devices of one or the other. This action implies there is no movement by the other party onto another's device. Additionally two individuals can create a similar singular squiggle on their respective devices within a defined radius from inches to thousands of miles. The accuracy of similarity diminishes beyond human audible and visual range as within that range its conceivable that two parties can agree to a iSquiggle and respond within a few seconds. If the server accuracy is diminished, then the probability of a match increases. Individuals using other means of communications can also create a match. When squiggles are drawn at random without any communication between each party and regardless of distance there is still a chance for two parties to create near identical iSquiggles. When that happens the event becomes more of the basis for a game. In this case we call the game Quantum Match.

Quantum Match reinforces the quantum and synchronistic theory that similar events can happen at a given instant regardless of distance and time and for reasons that are often difficult to explain. As a game the idea is that various individuals participate by drawing various iSquiggles and that design is instantly sent to a server which looks for matches. Simple iSquiggles create a greater degree of matching and thus a lower score. When high score designs match the individuals are deemed to be a Quantum Match and contact information can be exchanged if both agree. A user draws a squiggle and within a selected time interval and another person, it is assumed based on the theory of quantum physics gets a similar inspiration and creates the same squiggle. Both squiggles are reviewed on a server and within a specific narrow time from a match are determined. The score generated is based on the match accuracy and the relative time. Thus zero time and a perfect match between two parties receive an effect score of 100.

The players can be anywhere on Earth and that can be displayed on a globe for viewing others actual locations. Also solo users can play based on a server generating random designs with various levels of competition. Furthermore, images can be replaced with numbers, alpha characters and cards. The above feature may provide a man matching quantum interface or chance as a game. For those that do match if they wish they can exchange emails creating a unique one-to-one social network. The use of a single movement on each close device can have a time limit as 1/10 of a second to copy that of the other party and the error variables would have to open. Quantum Match as a game has another mode as between the server generating random iSquiggles and the user. The user creates an iSquiggle and when received another server generates a random iSquiggle which is returned to the user with the results.

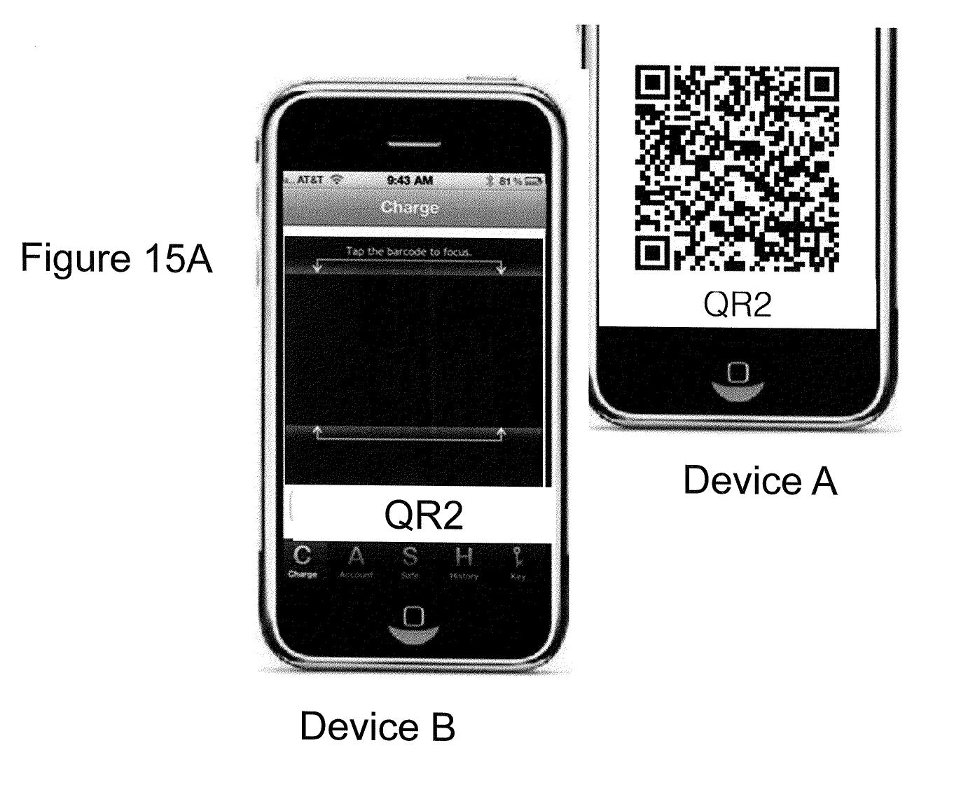

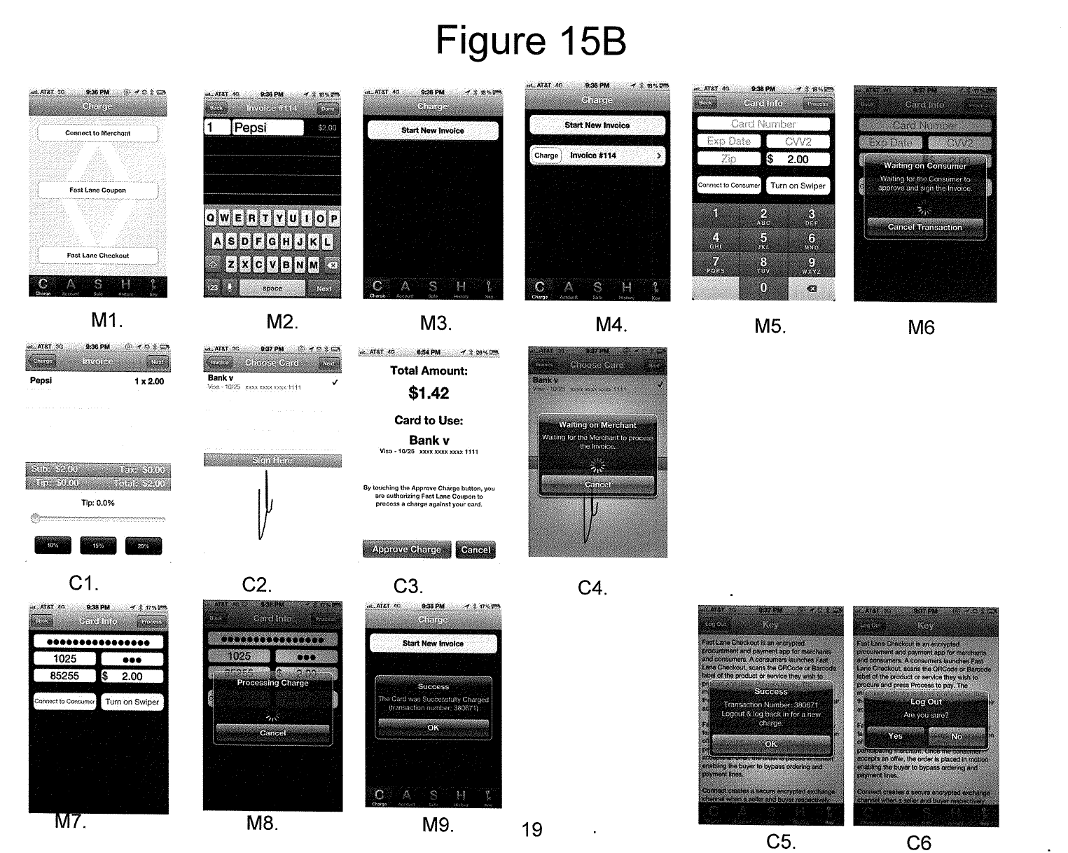

Referring to FIG. 15, QR2 will be disclosed. QR2 is a function that uses one device A to generate a QRCode that is read by another device B so as to create a unique channel and or to exchange unique information as unique authentication codes to invoices with both devices having the ability to assume reciprocal roles.

The QR2 system may contain two subsystems: iPhone and or Android Client or others. In operation, Device A generates a QR code and displays it. Device A sends the code to the server in background. The mobile client generates unique ID and sends to the server, so the ID is not requested from the server but rather sent to the server. Device B captures the QR code and gets: a. Session ID; b. Local IP; and c. Security token. Once device A ha accesses to device B, both devices exchange session information and IP addresses. After that this is two directions road and transfer is possible from A to B and from B to A.

QR2 may allow a user to select a picture on a device A and send the image to device B; transfer message or image data from device A to device B either: through the server, in this case device A sends data in small portion indicating the session ID, device B receives data and combines into the final piece; or directly through the local Wi-Fi. Alternatively, in the case where a device has no mobile connection a Wi-Fi passcode is sent to the visitor's device, so the visitor could use this passcode in the device settings. QR2 may further display data transfer performance: a. Data size; b. Transfer time; c. Speed; and the like.

For the QR2, the server should handle requests: 1. Register a communication session; 2. Get information about the communication session; 3. Creation new data transfer; 4. Get data transfer information; 5. Accept a portion of data; 6. Get a portion of data; 7. Data send completion; 8. Data receive completion (so the server could delete all transfer data).

Unique for each incident means the QR has a part of the code that changes thus, on an exchange between A and C devices the codes from A are different than given to B. Any new session should have a unique code.

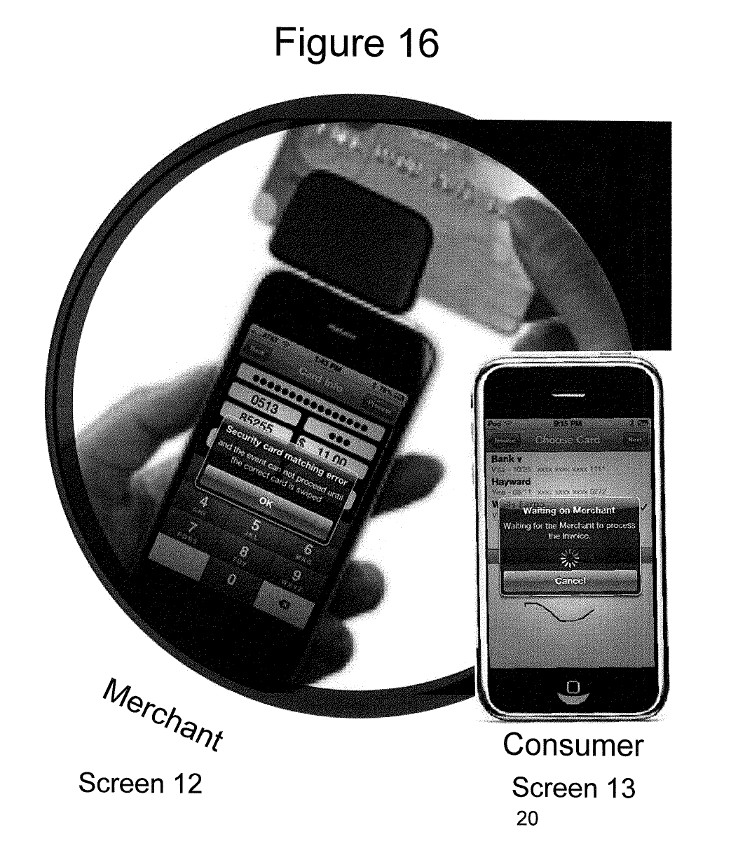

Referring to FIG. 16, Card2Match will be described. Card2Match is a function that allows a merchant using a smart phone or device to send a consumer an invoice via Bluetooth, cellular, WiFi or NFC to the customer's Smartphone or device. In operation, to create a one-to-one transaction the merchant creates an invoice. Selected items previously entered into the Account catalog are transfers via a secure connection to the consumer. Identity photo verifications may be exchanged for security. Upon acceptance, the invoice is sent to the consumer. Once the consumer receives the invoice, the consumer may review the invoice and then add an optional tip. The consumer may then select a credit card, and apply a signature. The consumer may send approval back to merchant where the merchant can proceed and process or request that same card to swipe.

If the merchant request that same card to swipe, the merchant presses a button on screen—Turn on Swiper (this removes the card information received from the consumer on the merchants screen), swipes the credit card, field is loaded with swiped card information, cvv numbers and zip are added, this new data from the swiped card is compared to the card information originally supplied and the two must match for security purposes to continue, Process button is pressed, card is Successful and shows up as such at both consumer and merchant and History is reflects properly on each device. The merchant may request the plastic card as the merchant gets a better rate with a swipe and with Card 2 Match all parameters must match or the transaction is thwarted.

When a merchant does not have Fast Lane app on a smart phone or a POS terminal and only accepts a credit card, but the consumer is enrolled in a feature of Fast Lane referenced as—Card 2 Match plus—that is activated on their Smartphone by touching the on (on/off) button superimposed on the image of the card in the Charge section of the consumer's Safe of the application, an e-card information related to the card selected is instantly relayed to the Card2Match plus server prior to giving the merchant their credit, debit, gift or stored value card. That opens the payment gateway window based on a time window and or amount and or location and or a transaction, which feeds into the Card 2 Match plus server, the card processor, card issuer and ultimately to a Bank as defined on the card. The Card 2 Match plus server compares and or authenticates that information and or uses an encrypted key to allow entry of the consumers shortly to arrive swiped credit card entered or swiped by the merchant. Should the card be presented without the proper pre-authorized encrypted e-card or not sent that rejects the transaction as the switch to the processor is not turned on. A lost card is thus worthless and if used without Card 2 Match plus is of no value.

If so used without activation that information is further sent to the consumer's Smartphone for a disposition. Currently banks have a card termination switch that a customer may call to say turn off use of a card. With the Card 2 Match plus feature, the choices are expanded. The pay gate switch is off and only activated for a short duration by the consumer as defined by time, amount or location or the transaction from the consumer's smart phone. Card 2 Match plus is designed to work with NFC, plastic cards and Internet e-payment methods. When two devices have the Card 2 Match plus application the (on/off) Turn on My Card feature is triggered on for that transaction when devices and or related accounts using various communications exchange secure information.

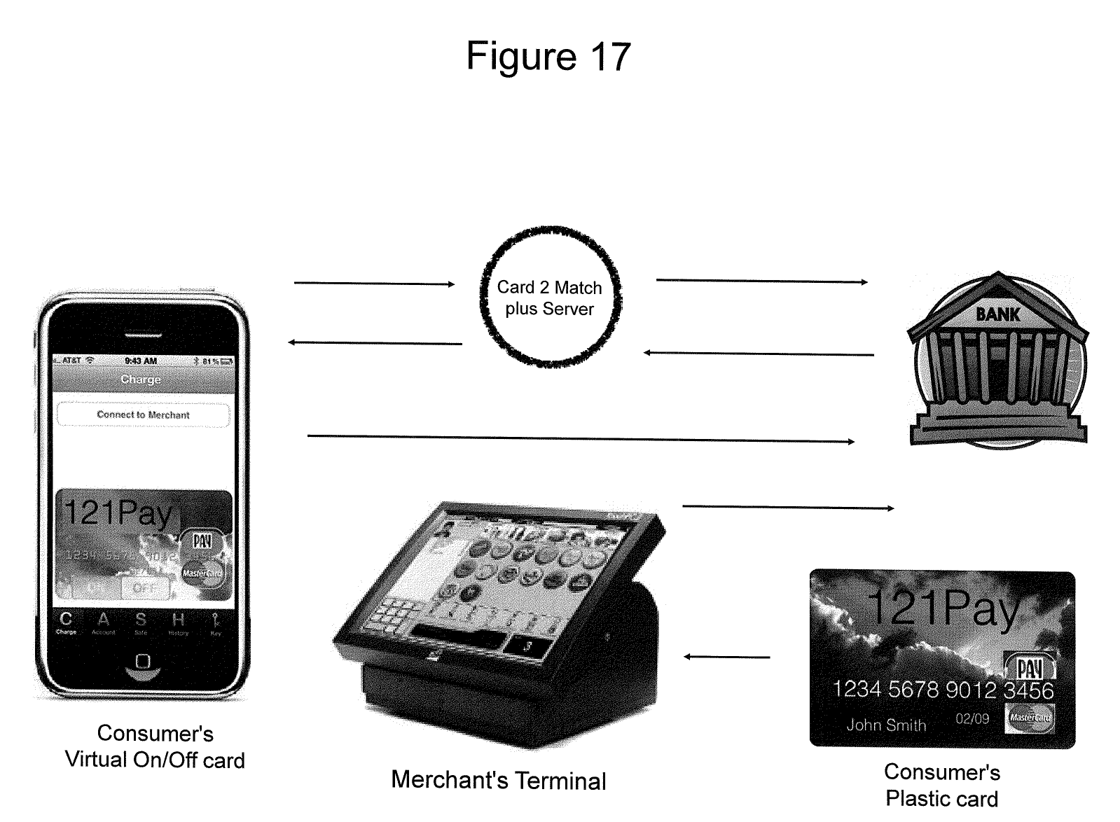

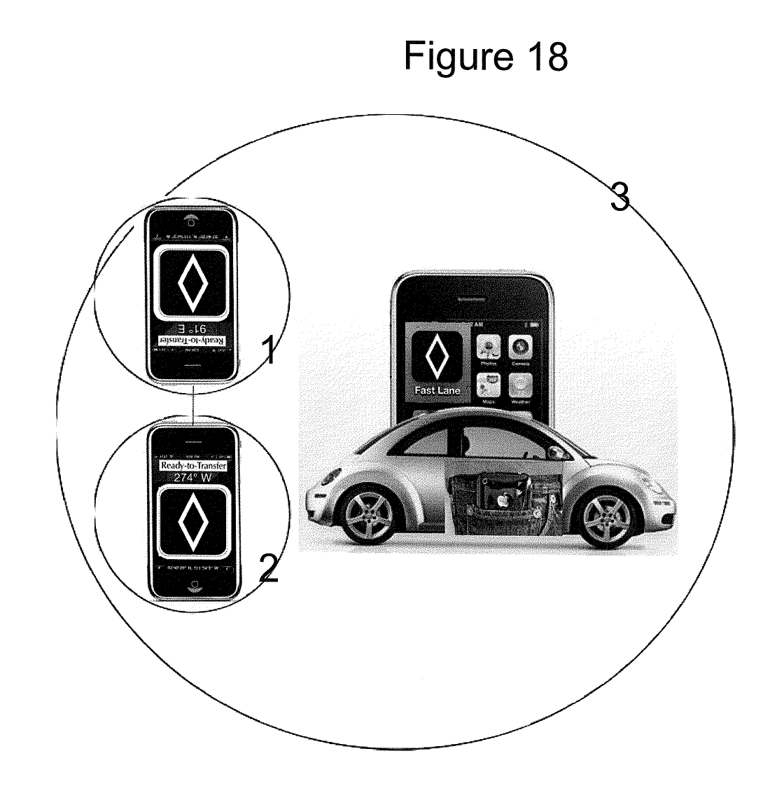

As shown in FIG. 17, if a merchant has POS without Card 2 Match plus, the consumer selects the Virtual card and gives the Plastic card to a Merchant. The application sends a SSL encrypted signal to the server linking the subscribing issuing Bank. After the transaction the card is latched and is inoperative until the next transaction

The app may further have a Hands Free feature. When the Hands Free feature is on, the driver never has to remove the Smartphone from a pocket to trigger the location reference as the application knows when the driver has departed and returned to their vehicle. This Automated feature when activated sets the car's location as a 3rd reference point allowing payments only within a specified programmable area. When Hands Free is on, the driver never has to remove the Smartphone from a pocket. In the hands free mode, the user sets this feature in the Account section.

The premise of the Hands Free mode of operation is that once the hands free mode is turned on essentially no further action is required on the part of the user when the device is working in conjunction with a reference located within the vehicle as the Bluetooth link to the hands free pairing within the vehicle relating to arrival/departure information. Once a change of state is determined as the engine is turned off and or a Bluetooth signal is deactivated as out of its communication range the app sends a signal containing latitude and longitude, effective radius and other required information to the server. The GPS signal or location information received by the smart phone has to fall into certain high accuracy limits thus referenced as super signal on the lower segment of the app signal strength reader which does not have to be viewed necessarily by the user. Since the signal is fairly accurate and the minimal range is 150 meters there is no need on the part of the user to absolutely define the exact position. Using the hands free mode the user assumes that they are at or near a specified location and that they are willing to use this feature as other location points are required to complete a transaction.

In the Hands Free mode, a payment radius and or area payment restrictions rules are used to extend security parameters beyond two or more points such that this feature when activated sets the cars location as a third reference point allowing payments only within a specified programmable radius and when this feature is on the driver never has to remove the smart phone or like device from a pocket to trigger the location reference as the application knows when the driver has departed and returned to their vehicle.

FIG. 18 illustrates payment radius restrictions. When activated manually or using the Hands Free option sets the cars location as a third reference point allowing payments only within a specified programmable radius.

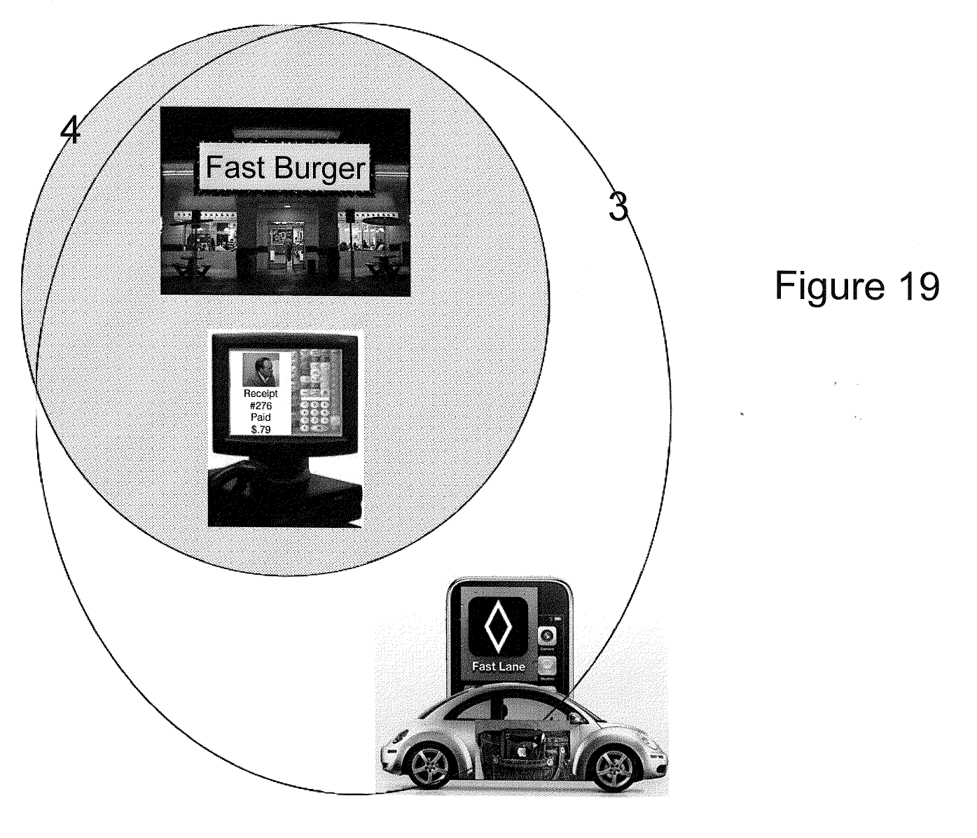

Referring now to FIG. 19, Fast Lane Order mode is disclosed. In Fast Lane Order, one may purchase items automatically via a Smartphone or other wireless communication device. By using Fast Lane Order, a previous order can be launched either manually or it can be totally automated selecting an order set in the History section under favorites or associated with that merchant or receiving an offer that was into the Add Item screen sequence. As the customer approaches the Restaurant's location zone 4 and the consumers vehicle defined zone 3 when leaving the vehicle with the Hands Free feature set on, the order is sent to the merchant with payment verification and a photo image of the consumer and the consumer picks up the order without taking the Smartphone out of their pocket using the modes disclosed above. Alternatively, if a vehicle is not used to establish zone 3, the consumer when walking into zone 4 can launch the app and use the devices zone 1 to launch the preferential order as described above.

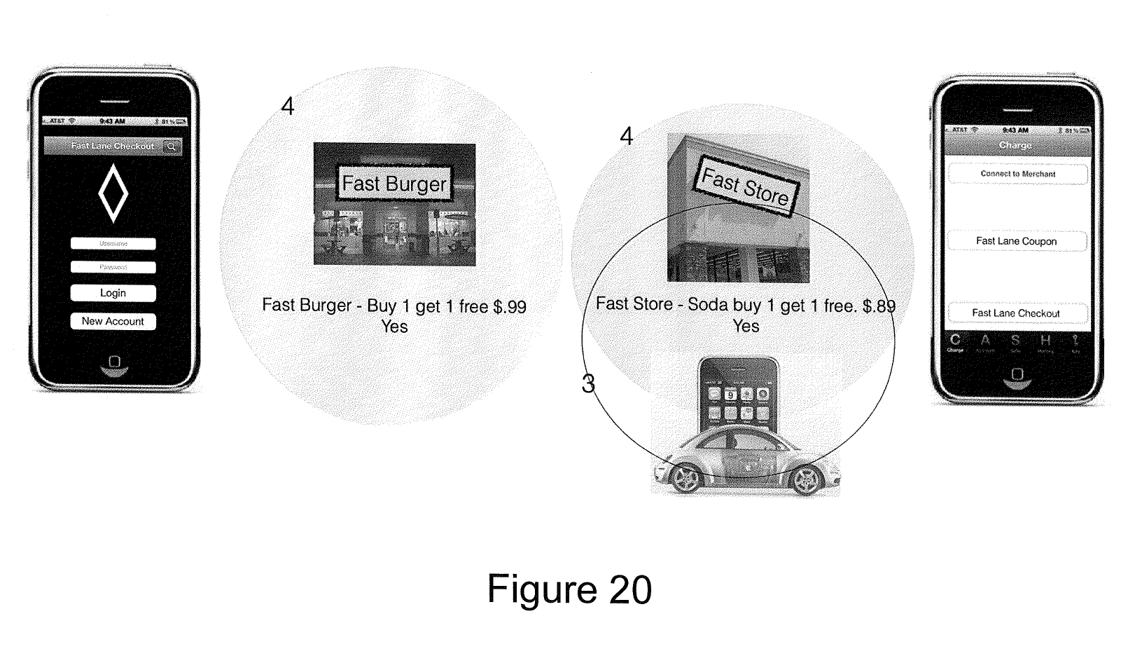

Referring to FIG. 20, the Fast Lane Coupon portion of the app will be described. Fast Lane Coupon may be launched in the app either after pressing the search icon or from within the app. Fast Lane Coupon provides automated merchant offers when the consumer is in a predefined radius of the merchant. When the customer enters a predefined radius of a merchant, a popup on the Smartphone may display a specific merchant's offer, price and merchant credentials with a option yes to purchase the offer. If yes is pressed that information is placed into the Invoice sequence for Fast Lane Checkout and places an order bypassing ordering and payment lines. The coupon offer disappears upon leaving the predefined radius. Upon entering another radius the new merchant's coupon appears. When in an undefined area as between identified merchant areas a popup appears with a rotating widget—“Searching for Fast Lane Coupon offers”—and time out is within minutes.

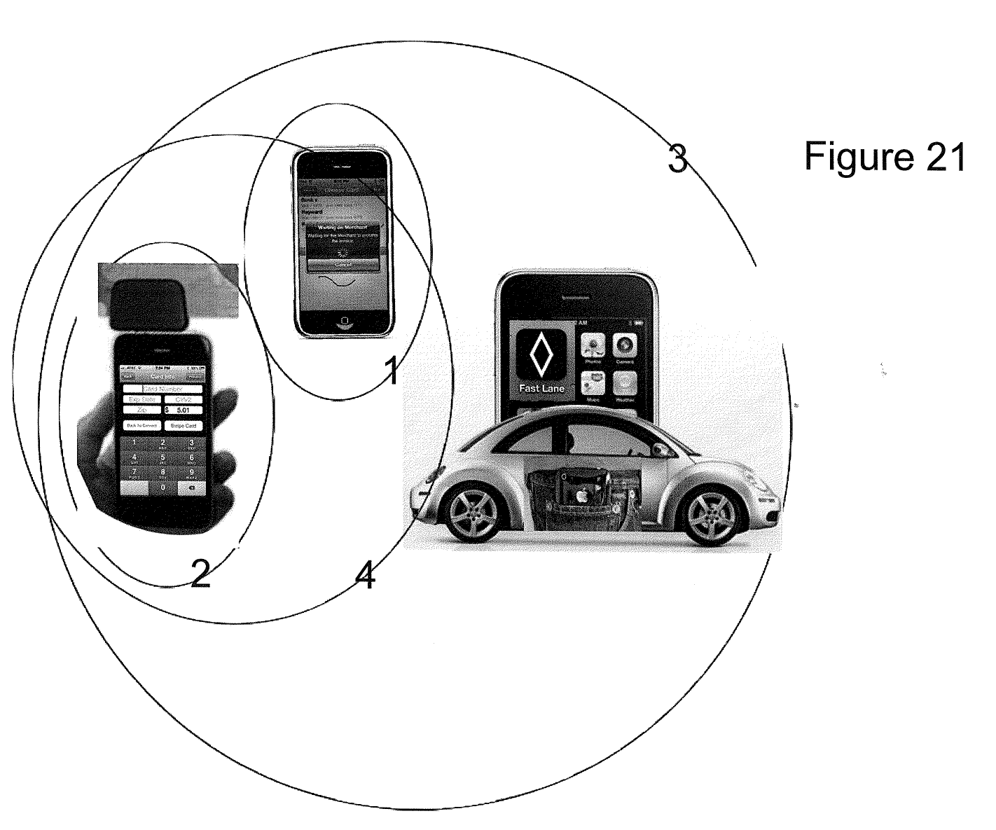

The app may have a Payment Area Restrictions and Automated Exchanges as shown in FIG. 21. When this feature is on a driver Smartphone/device 1, the driver never has to remove the Smartphone from a pocket to trigger a preset location 3 reference as the application knows when the driver has departed and returned to their vehicle. When the driver's device 1, in this case the buyer, and another parties device 2, the merchant, are within defined zones and overlapped from a 3rd zone, as the car when leaving it, and setting that zone with device 1, the user of device 1 may elect to 1) use a card and receive confirmation receipts automatically or 2) pre authorize device 2 to transmit the invoice to device 1 and device 1 having acquired overlapping location verification, as are within the merchant's area 4, their payment credentials, and the device never has to be removed from the buyers pocket and the payment is executed with payment notifications sent to both parties.

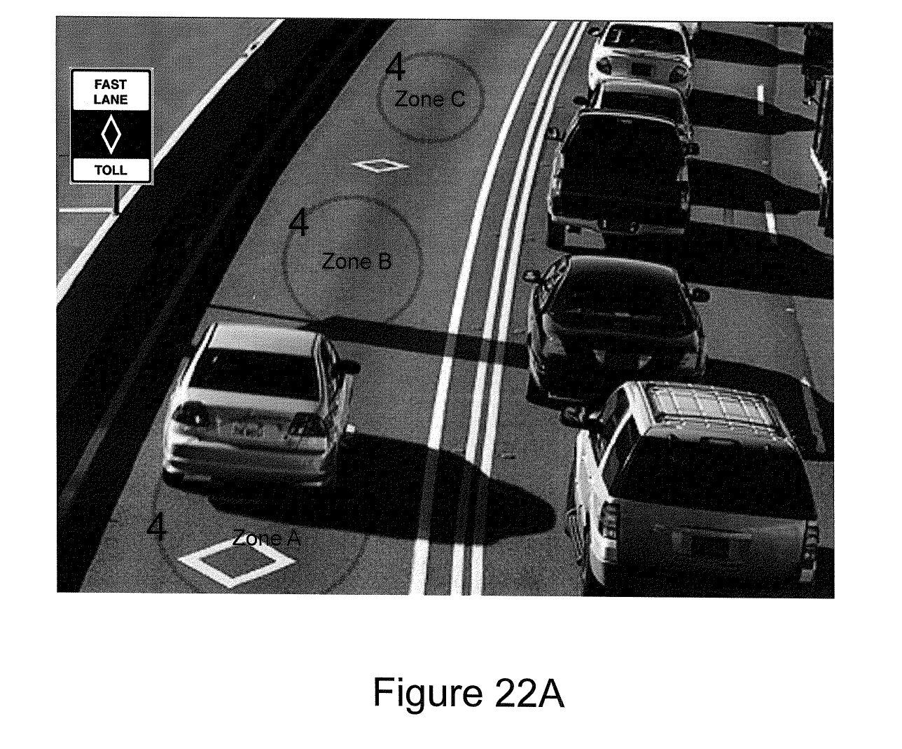

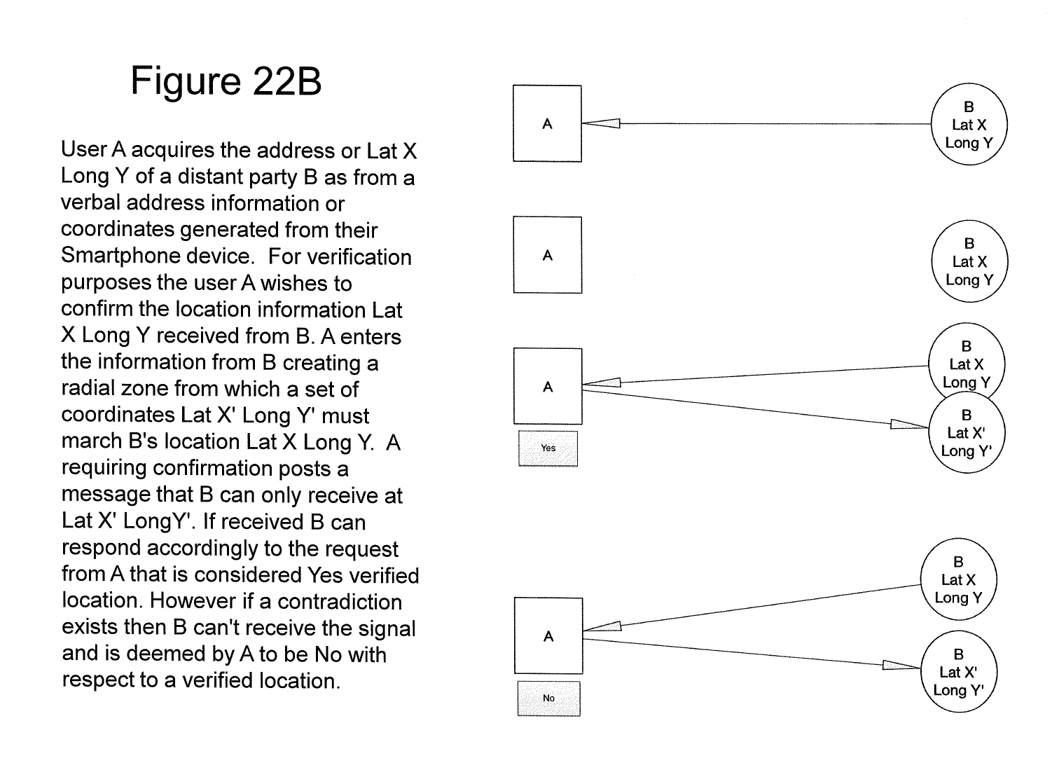

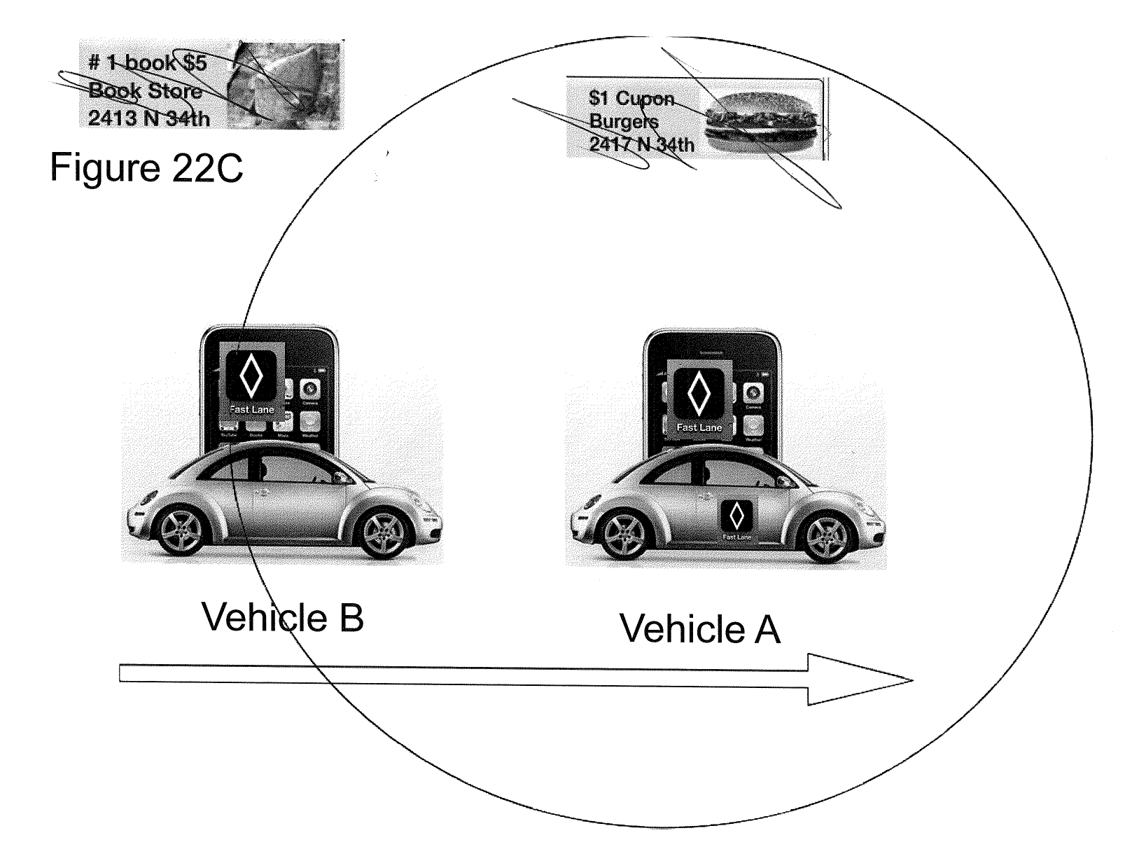

Referring now to FIG. 22A, the Hands Free presence or absence feature has extended functionality and can work with the micro zone 4 features or can function semi-automatically. On toll roads, Hands Free working with other Fast Lane payment features is turned on automatically as when entering or leaving a specific series of micro 4 road zone. Payments are made to the highway Fast Lane Toll authority. Roads can be defined with one, two or multiple small zone 4 radius location (Zones A B C) to create virtual road shapes to match the physical road so when a drivers device such as a Smartphone, using the paired coupled Bluetooth hands free feature and the vehicle enters one of these zones at any point, automatic payments occur and ends when departing any zones. Another use is the relationship in preventing the Smartphone's use as related to drivers texting, sending emails, playing games etc at inappropriate times, as when driving, by disabling or enabling certain functions automatically within the device based on the presence or absence feature and associated range areas as intersections and high density traffic zones.

As shown in FIG. 22B, User A acquires the address or Lat X Long Y of a distant party B as from verbal address information or coordinates generated from their Smartphone device. For verification purposes the user A wishes to confirm the location information Lat X Long Y received from B. A enters the information from B creating a radial zone from which a set of coordinates Lat X′ Long Y′ must march B's location Lat X Long Y. A requiring confirmation posts a message that B can only receive at Lat X′ Long Y′. If received B can respond accordingly to the request from A that is considered Yes verified location. However if a contradiction exists then B can't receive the signal and is deemed by A to be No with respect to a verified location.

Referring to FIG. 22C, Vehicle A has a user equipped with a Smartphone that is perpetually transferring and updating Lat Long position information to the Fast Lane server. The intersect radius set at the server is set so that another device as in Vehicle B when searching for coupons or offerings or messages of a certain type will receive that information.

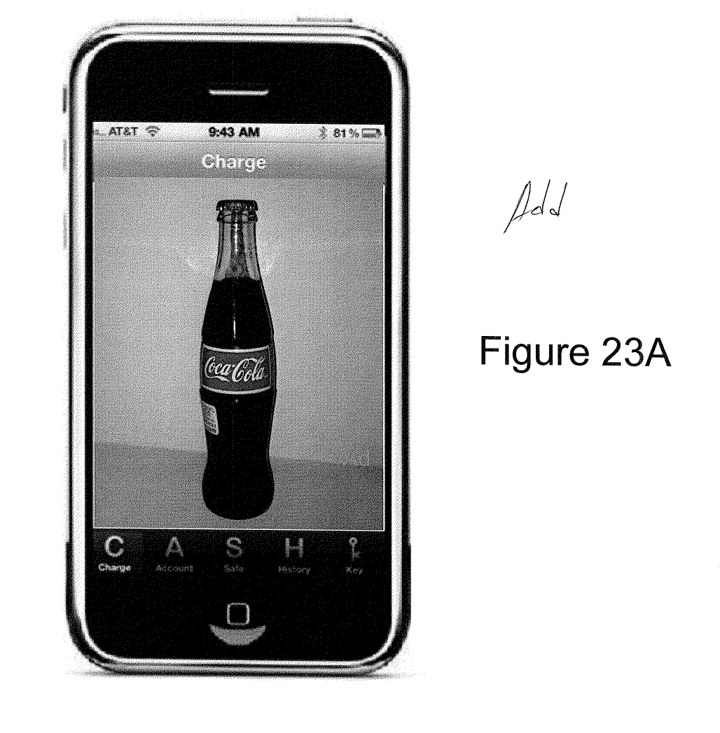

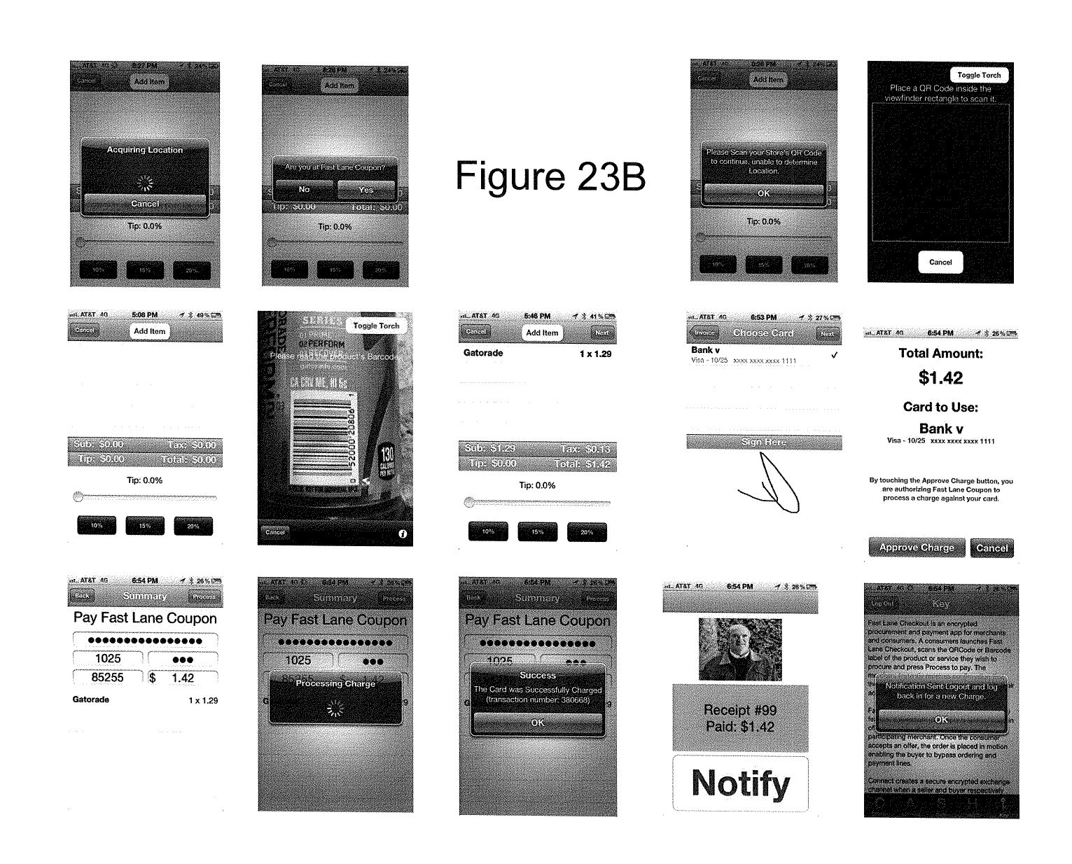

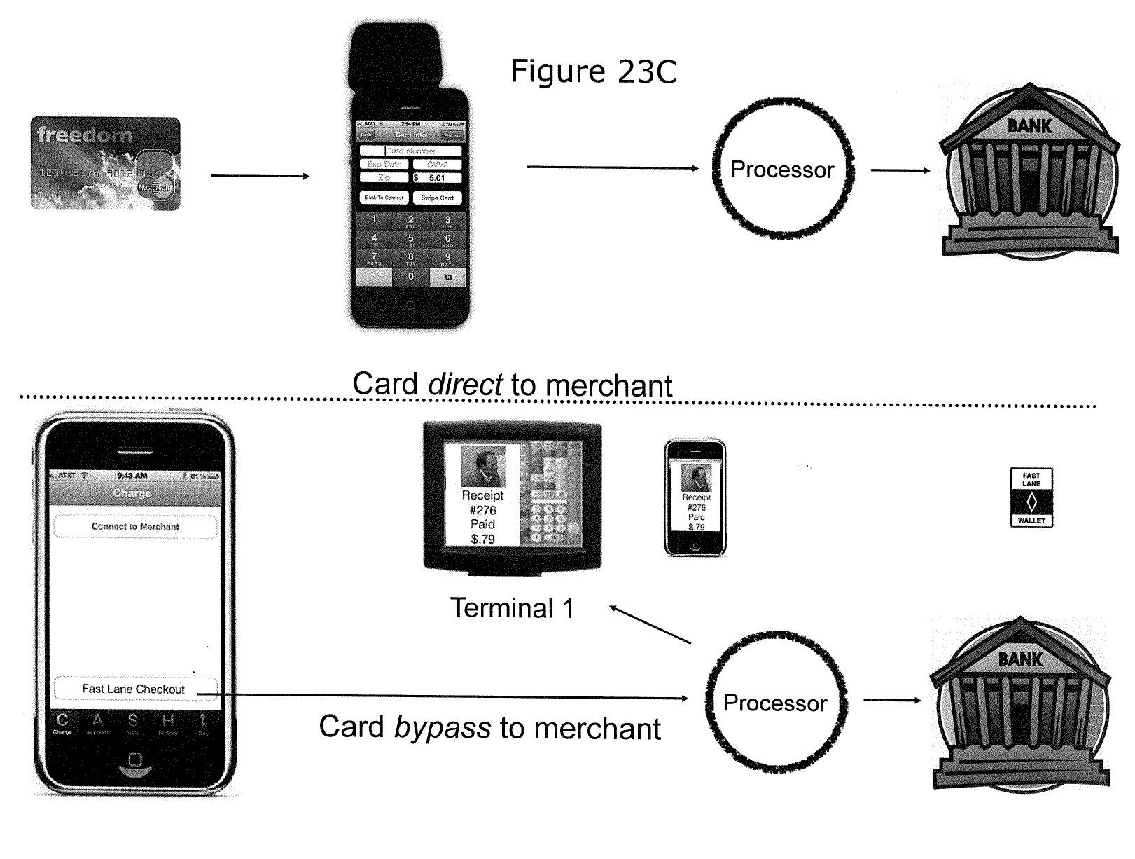

Referring now to FIG. 23A-23C, Fast Lane Checkout will be disclosed. Fast Lane Checkout is a consumer controlled payment terminal application that allows Smartphone to scan and pay for a product in one motion without exposing credit card information. Credit cards are kept in the consumer's encrypted Safe as described above.

Bar code and text is read at the merchants entrance or checkout, customer scans the QR code, signs up or logs into the app, merchants IP and or account Key is captured and or location information acquiring that related information from a server, loaded into the Account screen and application, staying there in a truncated view and only for that session, if the merchant uses a locked axis point the password is included, and alternatively, the merchant has an assigned unlocked WiFi router identified as “Fast Lane Checkout” that is detected and displayed on the consumer's Smartphone, taking a new user to sign up and connecting an existing user so as to acquire and load the merchant's Account Key. Transactions charges are determined from the total of scanned items and tax, (Credits are issued from the merchant's Management screen). Auto logout starts after 15 minutes of no activity but items selected for payment can remain until payment or cancellation of the invoice, and space is provided for promotions and that can use location information and or QR codes to determine the superimposed muted layer advertisement image or video presented on this page and or others that can be used to offset transaction fees.

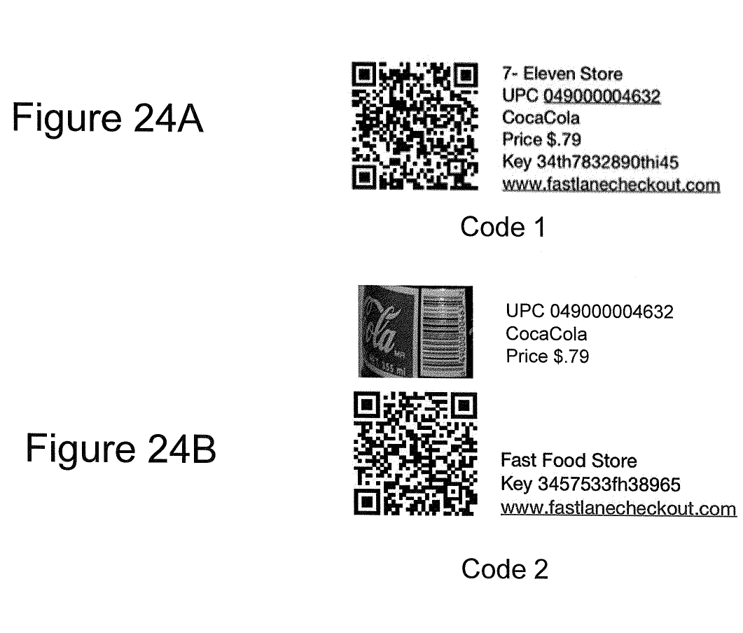

As shown in FIGS. 24A-24B, Shelf Scan—QR code objective is to link a product name (or invoice number), price, merchant Key and a sign up link for new users to a web page that links to the app for download from a merchant's Shelf Scan. Alternatively, a QR code sign may contain only the merchant Name, Key and a signup link for new users to a web page that links to the app for download. The app reads a Barcode to capture the product UPC data. The UPC is presented to a specific merchant's database, matched to the merchant's unique price, description and that is posted in the device price field. New users can enter the web address or use a standard QR code reader to initially connect to Fast Lane Checkout to acquire the application.

As shown in FIGS. 24A-24B, when a registered consumer scans a QR code of a product, the Consumer's Smartphone displays the product (if image is available otherwise state No Photo), photo of the Consumer from the Safe and receipt. An email, SMS or data pack to a computer as to confirmation of a Charge or Credit is sent from the server matching the Key to the specific merchant's email after the Success popup appears. When the Notify button is pressed a second Charge receipt is sent to the merchant, should that be required by the merchant when the customer leaves the merchant's store.

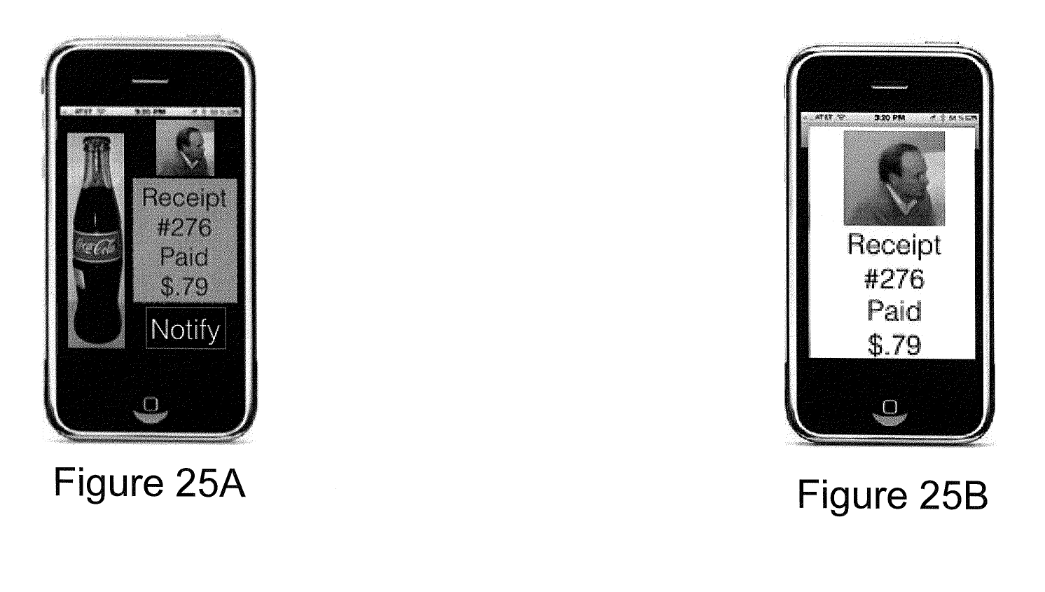

Referring to FIGS. 25A-25B, Consumer's Smartphone displays the product, photo and receipt. When the Notify button is pressed the receipt is sent to the merchant for a second confirmation via email when checking out and or to the merchant's POS terminal.

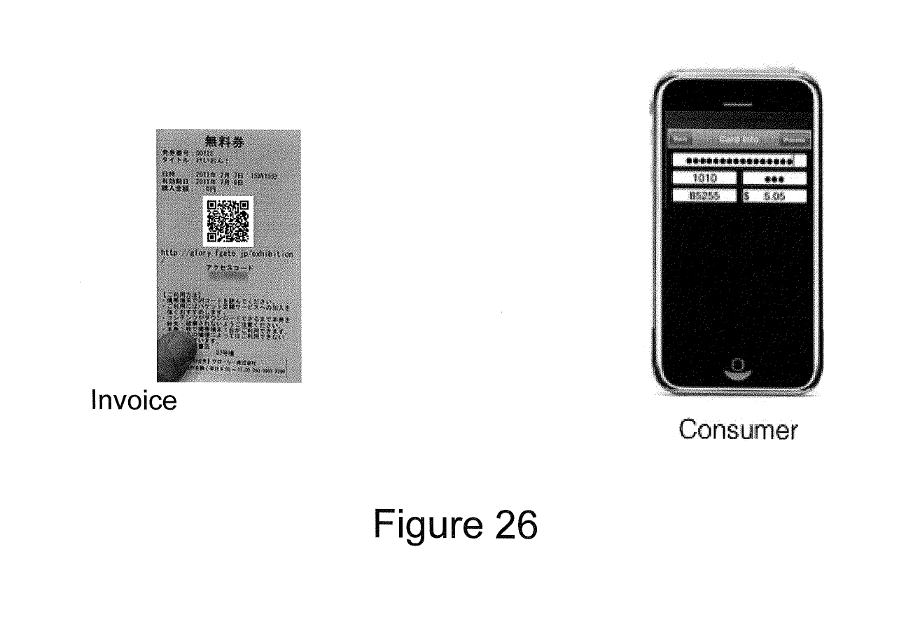

As shown in FIG. 26, if a paper receipt is given, the Consumer may use the Smartphone to capture the QR code from the invoice containing: price, Key and the invoice number. The customer presses process which transfers the funds to the merchant's account via the account Key. Acknowledgments may then be sent to both parties confirming the transaction.

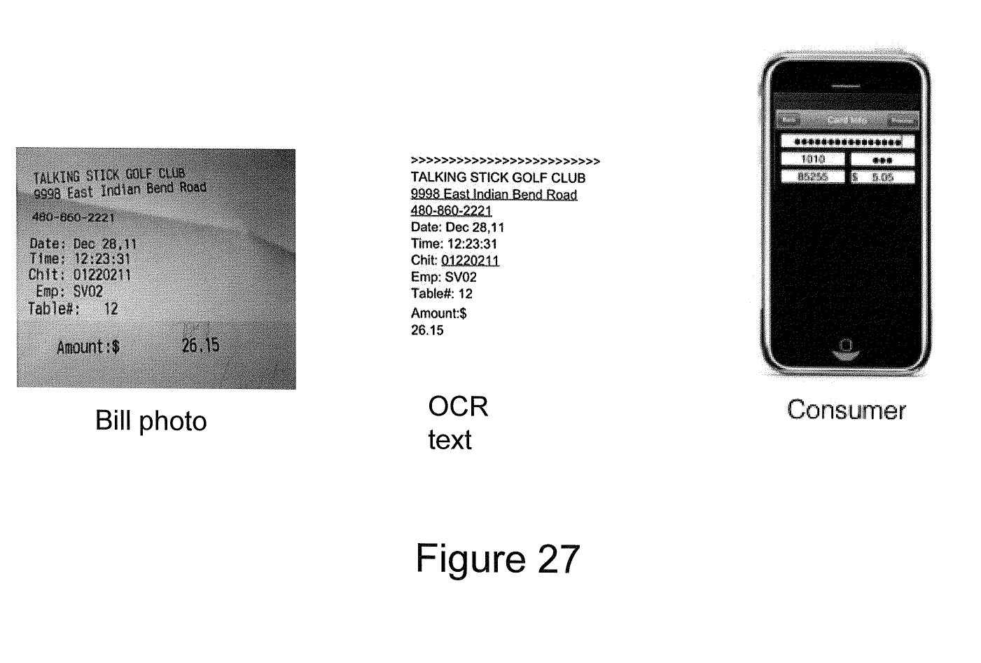

Alternatively, as shown in FIG. 27, if no QR code is issued, the Consumer may capture the invoice via a photo. The photo may be decoded by the OCR reader in the app, or remotely from a server, converted to digital text and places data in combinations of screens and the photo image of the bill is stored in History with the other associated Charge documents after a successful transaction. The customer presses process which transfers the funds to the merchant's account via the acquired Merchant's name, location and address compared to database of participating merchants on a server or if the Key is placed on the merchants bill that is used to route the payment. Acknowledgments are sent to both parties confirming the transaction.

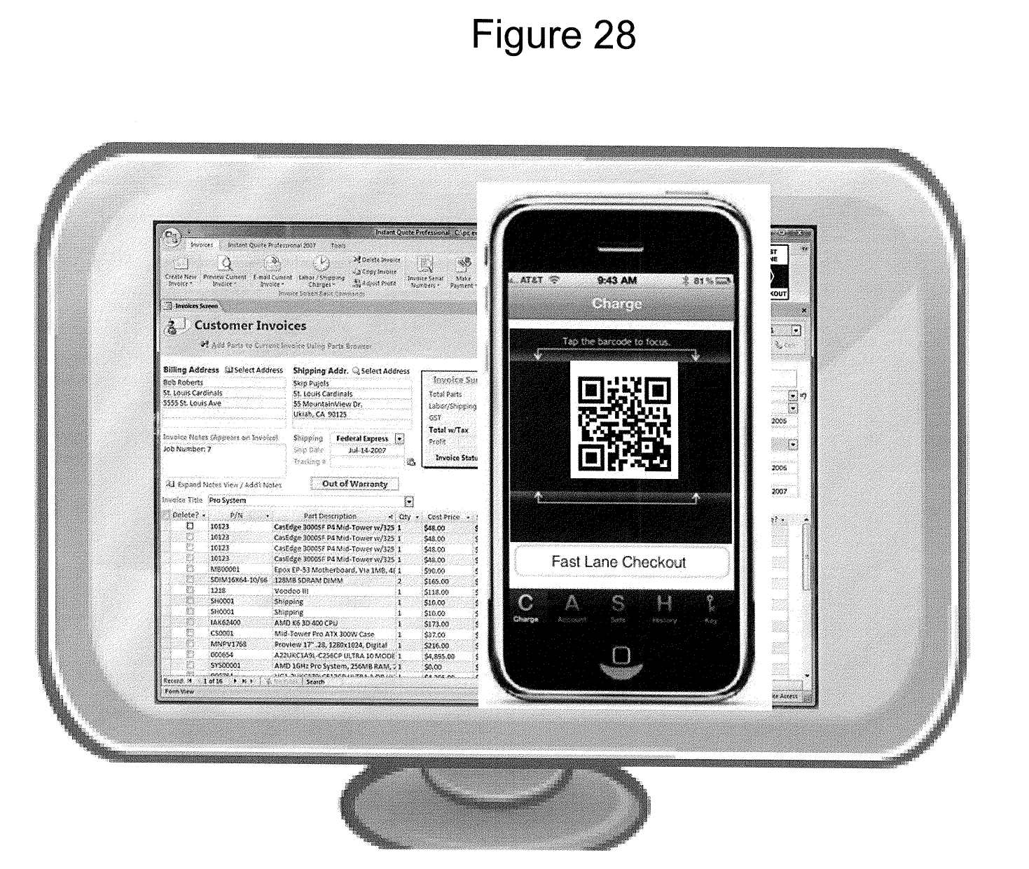

Referring to FIG. 28, Fast Lane Checkout will be described. Fast Lane Checkout scans a special QR code for a unique invoice presented on the computer screen. Information regarding the invoice is captured on the consumer's Smartphone. Payment is made via Fast Lane Checkout on the consumer's Smartphone so card information is not given to the merchant. The amount charged and the card details are sent directly to the processor. Both parties are notified of a successful transaction. The merchant has viewing privileges via their processors—my merchant account screen.

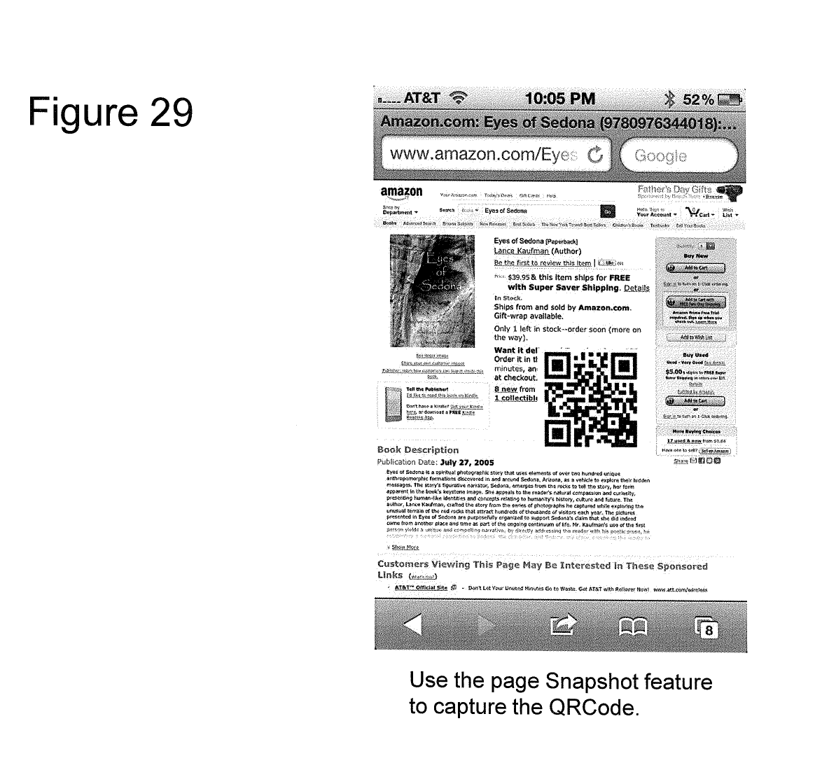

Referring now to FIG. 29, most Internet companies require the user to provide them with a credit card. In a one year time frame, a consumer could have gone through the process hundreds of times with each having separate password requirements. The consumer is charged a high rate by card associations because an Internet transaction is a card not present transaction. With Fast Lane Checkout you never have to expose card data as you don't have to register with hundreds of merchants and if you use the encrypted injected card swipe reader the consumer's card data is tokenized and viewed by the card associations as a card present transaction yielding the merchant a lower processing fee.

When using a Smartphone, tablet or computer as browsing a site and wishing to procure an item, the consumer can snap an image of the Fast Lane QRCode with that same device and place that into the Fast Lane Checkout section referenced—Read QRCode Snapshot. That image is decoded just as if the camera was used. All of your information as shipping etc is passed along to the merchant. Payment proceeds as defined in Fast Lane Checkout.

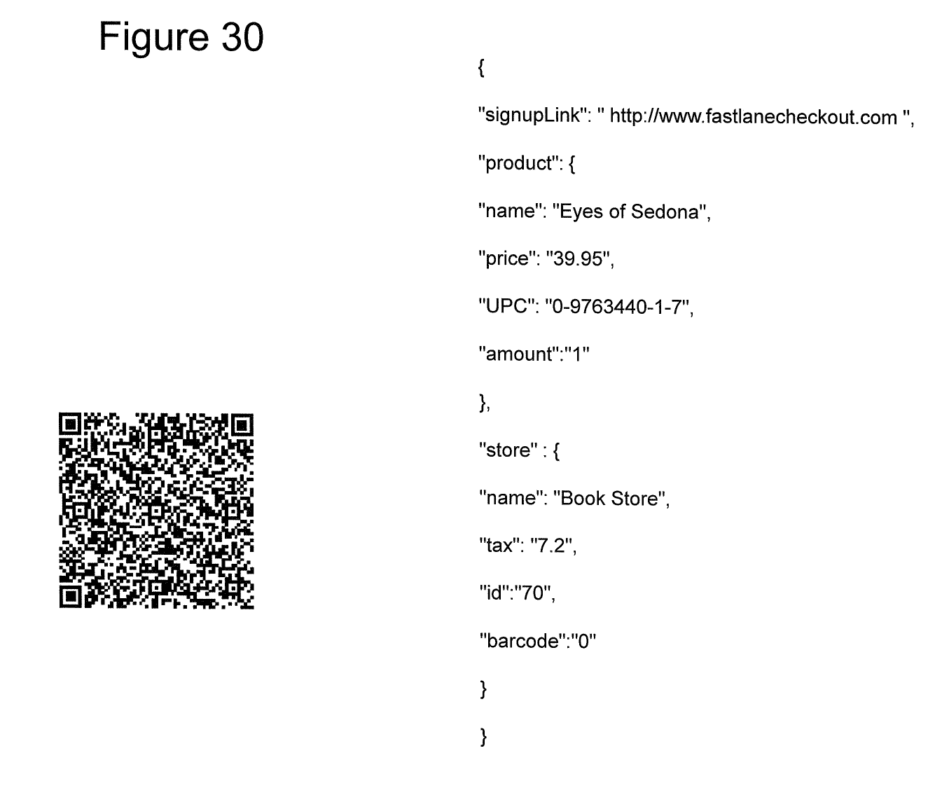

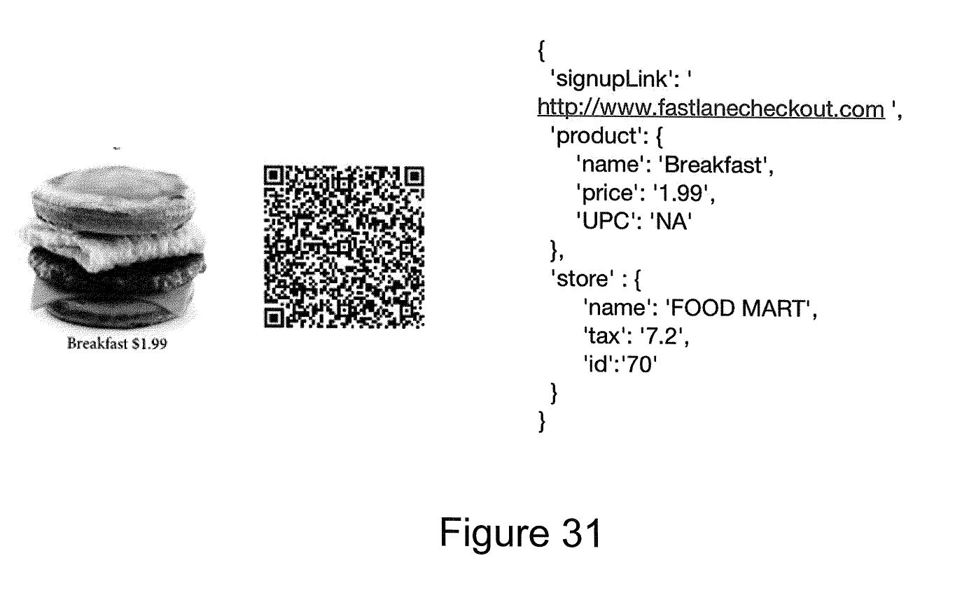

Referring to FIGS. 30-31, QR code templates are shown. Each QR code may provide the information as shown in the Figures. The QR code may further be used to link Fast Lane Checkout to a products logo and thus the product's logo to a consumer. The QR code may then be used to reward loyal consumers, provides a discount channel for frequency purchases, gives consumers Fast Lane Checkout privileges, etc.

While embodiments of the disclosure have been described in terms of various specific embodiments, those skilled in the art will recognize that the embodiments of the disclosure may be practiced with modifications within the spirit and scope of the claims.

What is claimed is:

1. A device having a processor, the processor executing program instructions causing the processor to:
storing credit card information of an individual in an encrypted format only readable by the processor;
function as a credit card terminal by receiving an invoice for payment, wherein a merchant key generated by the processor directs payment to a specified gateway; and
transferring funds from the individual to the specified gateway.

2. A device having a processor, the processor executing program instructions causing the processor to:
storing credit card information of a first individual in an encrypted format only readable by the processor;
receiving an invoice for payment by a second individual, wherein the merchant has a payment key generated by the processor to direct payment to a specified gateway; and
transferring funds from the first individual to the specified gateway.

3. A device having a processor in accordance with claim 2, wherein the program instructions further comprises generating the payment key, wherein the payment key is one of a unique time dependent and random key generated for each transaction and issued by the processor and sent to the second individual or a standard encrypted key.

4. A device having a processor in accordance with claim 2, wherein the program instructions further comprises reading credit card information via a card reader attached to the device.

5. A device having a processor in accordance with claim 2, wherein receiving the invoice and transferring funds is done wirelessly.

6. A device having a processor in accordance with claim 2, wherein the program instructions for storing credit card information of an individual in an encrypted format only readable by the processor further comprises selecting an image to set-up a memory safe for storing the credit card information, wherein the image is unalterable.

7. A device having a processor in accordance with claim 6, wherein the program instructions for selecting an image to set-up a memory safe further comprises:
deleting the program instructions, wherein all the credit card information is deleted;
reloading the program instructions;
selecting new image; and
entering the credit card information.

8. A device having a processor in accordance with claim 2, wherein the credit card information is uneditable once entered, and only a limited truncated numbers may be viewed.

9. A device having a processor in accordance with claim 2, wherein the credit card information stored in the encrypted format is stored as one of encrypted data packet or as a token associated with each set of credit card information, each set of credit card information being unviewable other than a truncated number set.

10. A device having a processor in accordance with claim 2, further comprising program instructions to create a secure encrypted exchange communication between the first individual and the second individual.

11. A device having a processor in accordance with claim 2, further comprising program instructions to create a secure encrypted exchange communication between the first individual and the second individual that allows identity, invoice, billing, transaction and receipt history to be exchanged between using the device and a device of the second individual in proximity to each other.

12. A device having a processor in accordance with claim 2, further comprising program instructions to create a secure encrypted exchange communication wirelessly between the first individual and the second individual.

13. A device having a processor in accordance with claim 2, further comprising program instructions to create unique exchange location reference points and reciprocal compass readings or parallel complementary readings between the device of the first individual and the device of the second individual, wherein one of motion or tapping of a screen of the device transfers data from the device to the second device.

14. A device having a processor in accordance with claim 2, further comprising program instructions to:
capture at least one of a marking on a screen or voice by as data information; and
sending the data information along with time and location from the device of the first individual and the device of the second individual for verification.

15. A device having a processor in accordance with claim 2, further comprising program instructions to:
capture at least one of a marking on a screen or voice as data information by the device of the first individual and the device of the second individual; and
sending the data information along with time and location from the device of the first individual and the device of the second individual for verification.

16. A device having a processor in accordance with claim 15, wherein the captured data information activates a specific function of the device.

17. A device having a processor in accordance with claim 15, wherein the captured data information is one of scrambled or encrypted.

18. A device having a processor in accordance with claim 15, wherein verification authorizes a desired transaction.

19. A device having a processor in accordance with claim 2, further comprising program instructions to:
capture at least one of a marking on a screen or voice as data information by the device of the first individual and the device of the second individual; and
sending segments of the data information from the device of the first individual and the device of the second individual, wherein the segment must match for verification.

20. A device having a processor, the processor executing program instructions causing the processor to:
create an invoice by a merchant;
transfer selected items entered into an account catalog to a device of a consumer;
sending an invoice to the device of the consumer wirelessly;
adding a desired tip by the consumer on the device of the customer;
select payment method on the device of the customer;
signing the invoice on the device of the customer; and
transfer the invoice back to the merchant.

21. A device having a processor, in accordance with claim 20, further comprising program instructions to read credit card information of the consumer and comparing the credit card information stored for verification.

22. A method for credit card payment comprising:
storing credit card information of a first individual in an encrypted format on a device of the first individual;
sending e-card information related to the credit card to a server prior to giving a second individual the credit card, wherein sending the e-card information opens a payment gateway window; and
authenticating credit card information to allow entry of the consumers shortly to arrive swiped credit card entered or swiped by the merchant.

23. A credit card payment method comprising:
sending an encrypted virtual card to an electronic device of a consumer and a corresponding physical card to a physical location for receipt by the consumer by a credit card issuing company; and
comparing the virtual card and the corresponding physical card, wherein the virtual card and the corresponding physical card must match to complete a transaction.

24. The credit card payment method of claim 23, wherein the encrypted virtual card comprises encrypted data, the encrypted data changed after each transaction, the changed encrypted data resent to the electronic device of the consumer.

25. The credit card payment method of claim 23, wherein the electronic device of the consumer sends a SSL encrypted signal to a server linking the credit card issuing company and after the transaction the credit card is latched and is inoperative until a next transaction.

26. A device having a processor in accordance with claim 2, further comprising program instructions to establishing a location radius, wherein transferring funds and verification is made only within the location radius.

27. A device having a processor in accordance with claim 2, further comprising program instructions to establishing a location radius, wherein advertising from one of a fixed location or a moving vehicle from a company within the location radius is sent to the device.

28. A device having a processor in accordance with claim 2, further comprising program instructions to capture QR code information of a product to be purchased, wherein a price of the product is added to the invoice.

29. A payment method comprising:
capturing a QRCode from a printed invoice of a merchant;
approving the invoice by a customer;
transfers funds to an account of the merchant via one of an IP or Key address translated from the QR code and or location information; and
sending confirmation of payment and receipt to the customer and merchant.

30. A method for tracking payment comprising:
purchasing electronic tokens, wherein each token has a plurality of identifiers related to a specific device and user;
transferring at least one electronic token during a transaction;
recording transfer of the at least one electronic token and the plurality of identifiers associated with the at least one token on a server; and
debiting and crediting a number of electronic tokens for each party of the transaction.

31. A device having a processor in accordance with claim 1, wherein the credit card information of the first individual is a tokenized equitant.

32. A device having a processor in accordance with claim 2, wherein the credit card information of the first individual is a tokenized equitant.
